(19) United States
(12) Patent Application Publication
(10) Pub. No.: US 2026/0040178 A1
(43) Pub. Date: Feb. 5, 2026

(54) CONFIGURATIONS FOR PROTOCOL DATA UNIT SETS

(71) Applicant: QUALCOMM Incorporated, San Diego, CA (US)

(72) Inventors: Sitaramanjaneyulu KANAMARLAPUDI, San Diego, CA (US); Ozcan OZTURK, San Diego, CA (US); Diana MAAMARI, San Diego, CA (US); Prasada Veera Reddy KADIRI, San Diego, CA (US)

(21) Appl. No.: 18/790,178

(22) Filed: Jul. 31, 2024

(51) Int. Cl. H04W 36/30; H04W 36/00; H04W 48/18

(52) U.S. Cl. CPC H04W 36/30; H04W 36/0011; H04W 48/18

(57) ABSTRACT

In some examples of the techniques described herein, one or more PDU set metrics or key performance indicators (KPIs) may be communicated between one or more UEs and network entities. For instance, a network entity may send configuration information to a UE for configuring the UE to communicate an indication of one or more KPIs associated with one or more PDU sets. The network entity and the UE may communicate the KPI(s). For instance, a UE or network entity may utilize one or more procedures to exchange one or more PDU set KPIs for enhanced coordination (e.g., information sharing) regarding traffic-oriented discarding or other behavior to enable changing scheduling patterns for improved KPI or service enablement. The KPI(s) may be utilized to modify the PDU set integrated handling information (PSIHI), PDU set delay budget (PSDB), PDU set error rate (PSER), or PDU set importance (PSI), among other examples.

### FIELD OF TECHNOLOGY

The following relates to wireless communications, including configurations for protocol data unit sets.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include receiving, from a network entity, configuration information for configuring the UE to communicate an indication of one or more key performance indicators (KPIs) associated with one or more protocol data unit (PDU) sets, where each PDU set of the one or more PDU sets includes a set of multiple PDUs associated with an application data unit (ADU) for communication between the UE and a network and communicating, with the network entity, the indication of the one or more KPIs associated with the one or more PDU sets based on the configuration information, where the one or more KPIs are associated with a quantity of lost PDU sets or discarded PDU sets of the one or more PDU sets.

A UE is described. The UE may include one or more memories storing processor executable code, and one or more processors coupled with the one or more memories. The one or more processors may individually or collectively be operable to execute the code to cause the UE to receive, from a network entity, configuration information for configuring the UE to communicate an indication of one or more KPIs associated with one or more PDU sets, where each PDU set of the one or more PDU sets includes a set of multiple PDUs associated with an ADU for communication between the UE and a network and communicate, with the network entity, the indication of the one or more KPIs associated with the one or more PDU sets based on the configuration information, where the one or more KPIs are associated with a quantity of lost PDU sets or discarded PDU sets of the one or more PDU sets.

Another UE is described. The UE may include means for receiving, from a network entity, configuration information for configuring the UE to communicate an indication of one or more KPIs associated with one or more PDU sets, where each PDU set of the one or more PDU sets includes a set of multiple PDUs associated with an ADU for communication between the UE and a network and means for communicating, with the network entity, the indication of the one or more KPIs associated with the one or more PDU sets based on the configuration information, where the one or more KPIs are associated with a quantity of lost PDU sets or discarded PDU sets of the one or more PDU sets.

A non-transitory computer-readable medium storing code is described. The code may include instructions executable by one or more processors to receive, from a network entity, configuration information for configuring the UE to communicate an indication of one or more KPIs associated with one or more PDU sets, where each PDU set of the one or more PDU sets includes a set of multiple PDUs associated with an ADU for communication between the UE and a network and communicate, with the network entity, the indication of the one or more KPIs associated with the one or more PDU sets based on the configuration information, where the one or more KPIs are associated with a quantity of lost PDU sets or discarded PDU sets of the one or more PDU sets.

Some examples of the method, UEs, and non-transitory computer-readable medium described herein may further include operations, features, means, or instructions for transmitting, to the network entity, capability information indicating a capability of the UE to communicate the indication of the one or more KPIs associated with the one or more PDU sets.

In some examples of the method, UEs, and non-transitory computer-readable medium described herein, the indication of the one or more KPIs indicates a first quantity of lost PDU sets associated with a PDU set integrated handling information (PSIHI) criterion, a second quantity of lost PDU sets associated with a discard timer expiration, a third quantity of lost PDU sets associated with a reordering timer expiration, or a combination thereof.

In some examples of the method, UEs, and non-transitory computer-readable medium described herein, the indication of the one or more KPIs indicates a first quantity of discarded PDU sets associated with a PSIHI criterion, a second quantity of discarded PDU sets associated with a resource limitation, or a combination thereof.

In some examples of the method, UEs, and non-transitory computer-readable medium described herein, the configuration information indicates an event or a periodic schedule for communicating the indication of the one or more KPIs and the indication of the one or more KPIs may be communicated based on the event or the periodic schedule.

In some examples of the method, UEs, and non-transitory computer-readable medium described herein, the configuration information indicates a configuration of medium access control-control element (MAC-CE) signaling, packet data convergence protocol (PDCP) signaling, or radio resource control (RRC) signaling for the indication of the one or more KPIs, the indication of the one or more KPIs may be communicated via the MAC-CE signaling, the PDCP signaling, or the RRC signaling, and communicating the indication of the one or more KPIs may be initiated by the UE or the network entity.

Some examples of the method, UEs, and non-transitory computer-readable medium described herein may further include operations, features, means, or instructions for switching from a first radio bearer (RB) to a second RB based on a trigger, where the configuration information indicates the trigger to switch radio bearers in a PDU session based on a PDU set delay budget (PSDB), a PDU set error rate (PSER), or a PDU set importance (PSI) metric.

Some examples of the method, UEs, and non-transitory computer-readable medium described herein may further include operations, features, means, or instructions for selecting a slice or a PDU session based on a trigger, where the configuration information indicates the trigger to select the slice or the PDU session based on the indication of the one or more KPIs.

Some examples of the method, UEs, and non-transitory computer-readable medium described herein may further include operations, features, means, or instructions for switching from a first cell to a second cell based on a cell reselection criterion or a handover criterion, where the configuration information indicates the cell reselection criterion or the handover criterion to switch cells based on the indication of the one or more KPIs.

Some examples of the method, UEs, and non-transitory computer-readable medium described herein may further include operations, features, means, or instructions for transmitting a request for the indication of the one or more KPIs via MAC-CE signaling, PDCP signaling, or RRC signaling.

Some examples of the method, UEs, and non-transitory computer-readable medium described herein may further include operations, features, means, or instructions for transmitting an indication of a trigger to switch radio bearers in a PDU session based on a PSDB, a PSER, or a PSI metric.

Some examples of the method, UEs, and non-transitory computer-readable medium described herein may further include operations, features, means, or instructions for transmitting information for modifying a trigger to select a slice or a PDU session based on the indication of the one or more KPIs.

Some examples of the method, UEs, and non-transitory computer-readable medium described herein may further include operations, features, means, or instructions for transmitting information for modifying a cell reselection criterion or a handover criterion to switch cells based on the indication of the one or more KPIs.

Some examples of the method, UEs, and non-transitory computer-readable medium described herein may further include operations, features, means, or instructions for transmitting information for modifying a scheduling request (SR) procedure, a random access channel (RACH) procedure, or a radio link failure (RLF) procedure based on the indication of the one or more KPIs.

Some examples of the method, UEs, and non-transitory computer-readable medium described herein may further include operations, features, means, or instructions for transmitting an indication of a discontinuous reception (DRX) configuration, a bandwidth configuration, or a multiple input or multiple output (MIMO) configuration via RRC UE assistance information (UAI) signaling based on the indication of the one or more KPIs.

In some examples of the method, UEs, and non-transitory computer-readable medium described herein, an artificial intelligence (AI) model may be trained based on the one or more KPIs associated with the one or more PDU sets.

Some examples of the method, UEs, and non-transitory computer-readable medium described herein may further include operations, features, means, or instructions for executing an AI model based on the one or more KPIs, where the AI model may be executed to set a timer associated with a PDU set, to select a PSI level, or to select a congestion procedure.

A method by a UE is described. The method may include receiving, from a network entity, configuration information for configuring a range for at least one parameter associated with one or more PDU sets, where each PDU set of the one or more PDU sets includes a set of multiple PDUs associated with an ADU for communication between the UE and a network and communicating, with the network entity, the one or more PDU sets based on the configuration information, where the one or more PDU sets are communicated based on a value selected from the range for the at least one parameter associated with the one or more PDU sets.

A UE is described. The UE may include one or more memories storing processor executable code, and one or more processors coupled with the one or more memories. The one or more processors may individually or collectively be operable to execute the code to cause the UE to receive, from a network entity, configuration information for configuring a range for at least one parameter associated with one or more PDU sets, where each PDU set of the one or more PDU sets includes a set of multiple PDUs associated with an ADU for communication between the UE and a network and communicate, with the network entity, the one or more PDU sets based on the configuration information, where the one or more PDU sets are communicated based on a value selected from the range for the at least one parameter associated with the one or more PDU sets.

Another UE is described. The UE may include means for receiving, from a network entity, configuration information for configuring a range for at least one parameter associated with one or more PDU sets, where each PDU set of the one or more PDU sets includes a set of multiple PDUs associated with an ADU for communication between the UE and a network and means for communicating, with the network entity, the one or more PDU sets based on the configuration information, where the one or more PDU sets are communicated based on a value selected from the range for the at least one parameter associated with the one or more PDU sets.

A non-transitory computer-readable medium storing code is described. The code may include instructions executable by one or more processors to receive, from a network entity, configuration information for configuring a range for at least one parameter associated with one or more PDU sets, where each PDU set of the one or more PDU sets includes a set of multiple PDUs associated with an ADU for communication between the UE and a network and communicate, with the network entity, the one or more PDU sets based on the configuration information, where the one or more PDU sets are communicated based on a value selected from the range for the at least one parameter associated with the one or more PDU sets.

In some examples of the method, UEs, and non-transitory computer-readable medium described herein, the at least one parameter associated with the one or more PDU sets includes a PSI level, a PSIHI criterion, a trigger associated with a PSDB, a priority associated with a PSDB, a RACH factor associated with a PSDB, a threshold associated with a PSDB, or a combination thereof.

Some examples of the method, UEs, and non-transitory computer-readable medium described herein may further include operations, features, means, or instructions for executing an AI model to select the value from the range for the at least one parameter, where a quantity of the one or more PDU sets may be discarded from the communication with the network entity based on the value that may be selected from the range for the at least one parameter.

In some examples of the method, UEs, and non-transitory computer-readable medium described herein, the quantity of the one or more PDU sets may be discarded based on the at least one parameter that includes a PSI level, and based on a resource schedule associated with the one or more PDU sets, protocol information associated with the one or more PDU sets, multi-modal information associated with the one or more PDU sets, frame information associated with the one or more PDU sets, or a combination thereof.

In some examples of the method, UEs, and non-transitory computer-readable medium described herein, the quantity of the one or more PDU sets may be discarded based on the at least one parameter that includes a PSIHI criterion, and based on application information associated with the one or more PDU sets, frame information associated with the one or more PDU sets, or a combination thereof.

Some examples of the method, UEs, and non-transitory computer-readable medium described herein may further include operations, features, means, or instructions for executing an AI model to select the value from the range for the at least one parameter that includes a PSIHI criterion, where the one or more PDU sets may be reassembled from the communication with the network entity based on the value that may be selected from the range, payload information associated with the one or more PDU sets, a type of traffic associated with the one or more PDU sets, or a combination thereof.

Some examples of the method, UEs, and non-transitory computer-readable medium described herein may further include operations, features, means, or instructions for executing an AI model to select the value from the range for the at least one parameter that may be associated with a PSDB or a PSI level, where the one or more PDU sets may be prioritized based on the value that may be selected from the range.

In some examples of the method, UEs, and non-transitory computer-readable medium described herein, the one or more PDU sets may be prioritized to override a configuration parameter associated with a buffer status report (BSR) or a data status report (DSR), may be prioritized for one or more packets during a retransmission, or may be prioritized to override a configuration parameter associated with a SR or a RACH procedure.

Some examples of the method, UEs, and non-transitory computer-readable medium described herein may further include operations, features, means, or instructions for executing an AI model to select the value from the range for the at least one parameter that may be associated with a PSDB or a PSI level for modifying a radio link control (RLC) level trigger, for modifying a retransmission procedure at a layer that may be lower than the RLC level, for modifying a resource for communicating the one or more PDU sets, or for reserving power.

Some examples of the method, UEs, and non-transitory computer-readable medium described herein may further include operations, features, means, or instructions for monitoring one or more KPIs associated with at least one PDU set and training an AI model based on the one or more KPIs, where the AI model may be trained to select the value from the range for the at least one parameter.

In some examples of the method, UEs, and non-transitory computer-readable medium described herein, the one or more KPIs indicate a first quantity of PDU sets that may be discarded due to a scheduling issue, a second quantity of PDU sets that may be discarded due to network congestion, a third quantity of PDU sets that may be discarded due to timer expiration, a fourth quantity of PDU sets that may be discarded due to a power limitation, or a combination thereof, and the AI model may be trained to select the value from the range based on the first quantity, the second quantity, the third quantity, the fourth quantity, or a combination thereof.

In some examples of the method, UEs, and non-transitory computer-readable medium described herein, the one or more KPIs indicate a first quantity of PDU sets that may be discarded due to a reordering timer expiration, a second quantity of PDU sets that may be missing due to a PSI level, a scheduling pattern of PDU sets, or a combination thereof, and the AI model may be trained to select the value from the range based on the first quantity, the second quantity, the scheduling pattern, or a combination thereof.

In some examples of the method, UEs, and non-transitory computer-readable medium described herein, the value selected from the range modifies a power limitation procedure, channel state information (CSI) reporting, adaptive receive diversity (ARD), or a combination thereof.

A method by a network entity is described. The method may include sending, to a UE, configuration information for configuring the UE to communicate an indication of one or more KPIs associated with one or more PDU sets, where each PDU set of the one or more PDU sets includes a set of multiple PDUs associated with an ADU for communication between the UE and a network and communicating, with the UE, the indication of the one or more KPIs associated with the one or more PDU sets based on the configuration information, where the one or more KPIs are associated with a quantity of lost PDU sets or discarded PDU sets of the one or more PDU sets.

A network entity is described. The network entity may include one or more memories storing processor executable code, and one or more processors coupled with the one or more memories. The one or more processors may individually or collectively be operable to execute the code to cause the network entity to send, to a UE, configuration information for configuring the UE to communicate an indication of one or more KPIs associated with one or more PDU sets, where each PDU set of the one or more PDU sets includes a set of multiple PDUs associated with an ADU for communication between the UE and a network and communicate, with the UE, the indication of the one or more KPIs associated with the one or more PDU sets based on the configuration information, where the one or more KPIs are associated with a quantity of lost PDU sets or discarded PDU sets of the one or more PDU sets.

Another network entity is described. The network entity may include means for sending, to a UE, configuration information for configuring the UE to communicate an indication of one or more KPIs associated with one or more PDU sets, where each PDU set of the one or more PDU sets includes a set of multiple PDUs associated with an ADU for communication between the UE and a network and means for communicating, with the UE, the indication of the one or more KPIs associated with the one or more PDU sets based on the configuration information, where the one or more KPIs are associated with a quantity of lost PDU sets or discarded PDU sets of the one or more PDU sets.

A non-transitory computer-readable medium storing code is described. The code may include instructions executable by one or more processors to send, to a UE, configuration information for configuring the UE to communicate an indication of one or more KPIs associated with one or more PDU sets, where each PDU set of the one or more PDU sets includes a set of multiple PDUs associated with an ADU for communication between the UE and a network and communicate, with the UE, the indication of the one or more KPIs associated with the one or more PDU sets based on the configuration information, where the one or more KPIs are associated with a quantity of lost PDU sets or discarded PDU sets of the one or more PDU sets.

A method by a network entity is described. The method may include sending, to a UE, configuration information for configuring a range for at least one parameter associated with one or more PDU sets, where each PDU set of the one or more PDU sets includes a set of multiple PDUs associated with an ADU for communication between the UE and a network and communicating, with the UE, the one or more PDU sets based on the configuration information, where the one or more PDU sets are communicated based on a value selected from the range for the at least one parameter associated with the one or more PDU sets.

A network entity is described. The network entity may include one or more memories storing processor executable code, and one or more processors coupled with the one or more memories. The one or more processors may individually or collectively be operable to execute the code to cause the network entity to send, to a UE, configuration information for configuring a range for at least one parameter associated with one or more PDU sets, where each PDU set of the one or more PDU sets includes a set of multiple PDUs associated with an ADU for communication between the UE and a network and communicate, with the UE, the one or more PDU sets based on the configuration information, where the one or more PDU sets are communicated based on a value selected from the range for the at least one parameter associated with the one or more PDU sets.

Another network entity is described. The network entity may include means for sending, to a UE, configuration information for configuring a range for at least one parameter associated with one or more PDU sets, where each PDU set of the one or more PDU sets includes a set of multiple PDUs associated with an ADU for communication between the UE and a network and means for communicating, with the UE, the one or more PDU sets based on the configuration information, where the one or more PDU sets are communicated based on a value selected from the range for the at least one parameter associated with the one or more PDU sets.

A non-transitory computer-readable medium storing code is described. The code may include instructions executable by one or more processors to send, to a UE, configuration information for configuring a range for at least one parameter associated with one or more PDU sets, where each PDU set of the one or more PDU sets includes a set of multiple PDUs associated with an ADU for communication between the UE and a network and communicate, with the UE, the one or more PDU sets based on the configuration information, where the one or more PDU sets are communicated based on a value selected from the range for the at least one parameter associated with the one or more PDU sets.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports configurations for protocol data unit (PDU) sets in accordance with one or more aspects of the present disclosure.

FIG. 2 shows an example of a network architecture that supports configurations for PDU sets in accordance with one or more aspects of the present disclosure.

FIG. 3 shows an example of a wireless communications system that supports configurations for PDU sets in accordance with one or more aspects of the present disclosure.

FIG. 4 is a block diagram illustrating examples of devices that support configurations for PDU sets in accordance with one or more aspects of the present disclosure.

FIG. 5 shows an example of a process flow that supports configurations for PDU sets in accordance with one or more aspects of the present disclosure.

FIG. 6 shows an example of a wireless communications system that supports configurations for PDU sets in accordance with one or more aspects of the present disclosure.

FIG. 7 shows an example of a process flow that supports configurations for PDU sets in accordance with one or more aspects of the present disclosure.

FIGS. 8 and 9 show block diagrams of devices that support configurations for PDU sets in accordance with one or more aspects of the present disclosure.

FIG. 10 shows a block diagram of a communications manager that supports configurations for PDU sets in accordance with one or more aspects of the present disclosure.

FIG. 11 shows a diagram of a system including a device that supports configurations for PDU sets in accordance with one or more aspects of the present disclosure.

FIGS. 12 and 13 show block diagrams of devices that support configurations for PDU sets in accordance with one or more aspects of the present disclosure.

FIG. 14 shows a block diagram of a communications manager that supports configurations for PDU sets in accordance with one or more aspects of the present disclosure.

FIG. 15 shows a diagram of a system including a device that supports configurations for PDU sets in accordance with one or more aspects of the present disclosure.

FIGS. 16 through 21 show flowcharts illustrating methods that support configurations for PDU sets in accordance with one or more aspects of the present disclosure.

### DETAILED DESCRIPTION

Some wireless communication systems communicate using protocol data units (PDUs). A PDU may be a set of information (e.g., a packet or frame of information) that is formatted in accordance with a protocol (e.g., transmission control protocol (TCP) or user datagram protocol (UDP), among other examples). For example, a PDU may include overhead information (e.g., a preamble, header, one or more control fields, or an address, among other examples) or payload data. In some examples, the payload data may include application data (e.g., text data, audio data, image data, video data, numerical data, or instructions, among other examples). In some aspects, the payload data for a PDU at a protocol layer may include information (e.g., a service data unit (SDU)) from a higher protocol layer.

Some wireless communications systems may communicate in accordance with a PDU set procedure. A group of PDUs may be identified as a PDU set for handling among a user plane function (UPF), radio access network (RAN), or user equipment (UE), among other examples. In some examples, a PDU set may be a group of PDUs that may be associated with an application data unit (ADU). An application data unit may be a set of information that may be communicated with an application (e.g., at an application layer). For instance, an ADU may correspond to a video frame, where the PDU set is utilized to transmit sets of data corresponding to the video frame.

In some approaches, communication (e.g., transmission or reception), discarding behavior, or prioritization behavior may be performed at a PDU set level of granularity. In some examples, one or more parameters may be utilized for PDU set handling. For instance, one or more parameters may be utilized to satisfy service level agreement (SLA) criteria for one or more services (e.g., extended reality (XR) or other services). Examples of the parameters may include PDU set integrated handling information (PSIHI), PDU set delay budget (PSDB), PDU set error rate (PSER), or PDU set importance (PSI), among other examples. In some examples, a UE or a network entity may perform PDU set handling, where a group of PDUs may be identified as a PDU set to ensure that transmission and block error rate (BLER) targets are met within a PSDB and a PSER, respectively. For instance, a PSER of 10% may be utilized to trigger discarding a PDU set if more than 10% of the PDUs in the PDU set are received unsuccessfully.

In some examples, PDU set handling may be performed based on one or more PDU set associations between packets for scheduling behavior or discarding behavior from a transmitter perspective. PSI may be utilized to indicate relative priority between PDU sets during one or more scenarios (e.g., for loading or congestion conditions from a transmitter perspective). For instance, PSI may be utilized to discard some traffic in a case of congestion.

In some cases, integrity criteria associated with one or more PDU sets may be utilized as part of PSIHI for discarding behavior from the transmitter perspective or BLER handling from the receiver perspective. For instance, the PSIHI may be utilized to process, deliver, or discard traffic based on whether one or more packets of a PDU set are discarded or lost.

In some approaches, RAN or resource management associated with the RAN may be performed based on one or more PDU set characteristics with the coordinated information between a core network and that RAN (without an explicit indication on the over-the-air (OTA) PDUs, for instance). In some examples, a network may determine one or more radio resource management (RRM) aspects based on one or more key performance indicator (KPI) values associated with PDU set performance.

In some cases, rigid PDU set handing (e.g., UE PDU set behavior) may be achieved at a cost of flexibility. For example, PDU set information and relative priority or handling behavior may be left to one or more upper layers based on internal traffic information (which may be coordinated with an application server on the network side). In some aspects, a buffer status report (BSR) associated with a PDU set may be utilized to indicate that a burst has not ended (e.g., the non-end of a burst) with a BSR value of 0. In some approaches, PDU set prioritization among outstanding information within a flow may not be defined with different priorities, but may be handled purely in order. PDU set KPIs may be utilized for some functional logics, but may not be utilized for other procedures.

A KPI may be a metric that indicates an aspect of communication performance. For instance, a UE may monitor one or more KPIs to assess performance. Some examples of KPIs may a quantity of discarded PDU sets or a quantity of lost PDU sets, among other examples. In some approaches, PDU set metrics or KPIs may be used to evaluate UE performance, but may not be used to modify any UE specific procedures. Additionally, or alternatively, the PDU set metrics or KPIs may not be communicated (e.g., exchanged) among entities (e.g., UEs and network entities). In uplink communications at a UE, for instance, PDU sets discarded due to PSI, PSIHI, or PSDB procedures may not be indicated to the network. In downlink communications, PDU sets discarded due to PSIHI or PSDB procedures may not be indicated to the network.

In some examples of the techniques described herein, one or more PDU set metrics or KPIs may be communicated between one or more UEs and network entities. For instance, a network entity may send configuration information to a UE for configuring the UE to communicate an indication of one or more KPIs associated with one or more PDU sets. The network entity and the UE may communicate the KPI(s). For instance, a UE or network entity may utilize one or more procedures to exchange one or more PDU set KPIs for enhanced coordination (e.g., information sharing) regarding traffic-oriented discarding or out-of-window (OOW) behavior to enable changing scheduling patterns for (e.g., for duplication of scheduling patterns for) improved KPI or service enablement. OOW behavior may refer to discarding one or more packets outside of (e.g., to a left side of) a sliding window. In some examples, the KPI(s) may be utilized to modify the PSIHI, PSDB, PSER, PSI, a cell reselection criterion, a handover criterion, a slice selection, a PDU session, a scheduling request (SR) procedure, a random access channel (RACH) procedure, a radio link failure (RLF) procedure, a discontinuous reception (DRX) configuration, a multiple input or multiple output (MIMO) configuration, or other aspect to enhance communication performance.

In some examples, a network entity may send configuration information for configuring a range of a parameter (e.g., PSIHI, PSDB, PSER, or PSI, among other examples) at the UE. The UE may select a value from the range of the parameter to enhance communication performance. In some examples, an artificial intelligence (AI) model may be trained or utilized to select the value. In some approaches, a UE may perform one or more operations such as autonomously initiating PDU set handling or influencing PDU set discarding or transmission rules. The one or more operations may be performed based on UE internal information, radio conditions, scheduling patterns, or a current RAN or core network-based PDU set configuration or bearer configuration. The one or more operations may be performed, for example, to improve service to meet an SLA when the outstanding buffers are not drained.

Aspects of the disclosure are described in the context of wireless communications systems. Aspects of the disclosure are also described in the context of a network architecture, block diagram, and process flows. Aspects of the disclosure are further illustrated by and described with reference to apparatus diagrams, system diagrams, and flowcharts that relate to configurations for PDU sets.

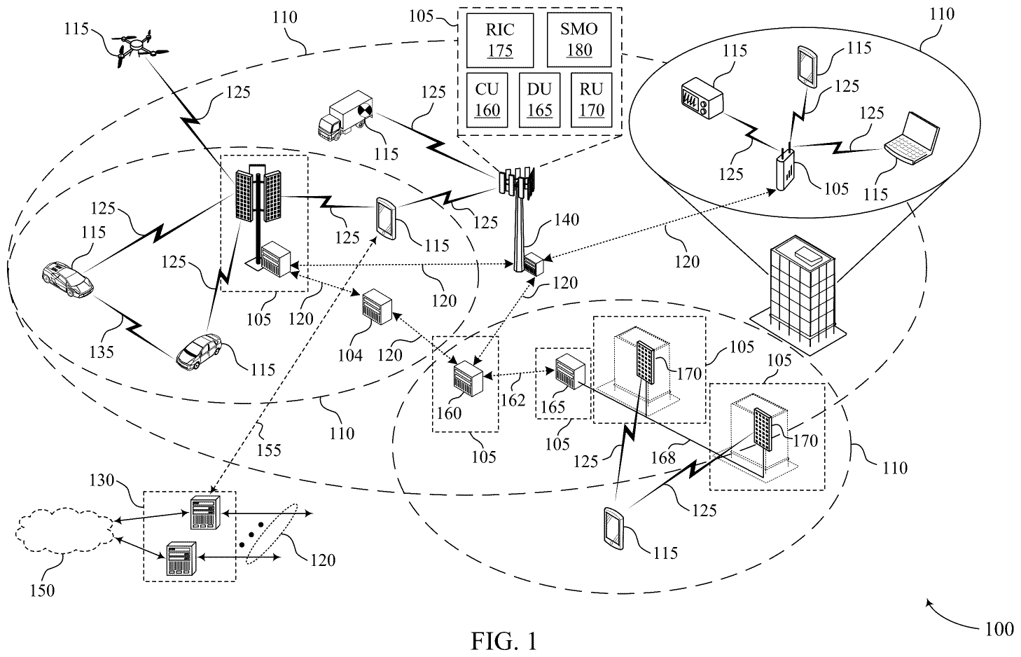

FIG. 1 shows an example of a wireless communications system 100 that supports configurations for PDU sets in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., radio resource control (RRC), service data adaptation protocol (SDAP), packet data convergence protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a UPF). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication systems 100 may communicate using PDUs. A PDU may be a set of information (e.g., a packet or frame of information) that is formatted in accordance with a protocol (e.g., TCP or UDP, among other examples). For example, a PDU may include overhead information (e.g., a preamble, header, one or more control fields, or an address, among other examples) or payload data. In some examples, the payload data may include application data (e.g., text data, audio data, image data, video data, numerical data, or instructions, among other examples). In some aspects, the payload data for a PDU at a protocol layer may include information (e.g., an SDU) from a higher protocol layer.

Some wireless communications systems 100 may communicate in accordance with a PDU set procedure. A group of PDUs may be identified as a PDU set for handling among a UPF, RAN, or UE 115, among other examples. In some examples, a PDU set may be a group of PDUs that may be associated with an ADU. An application data unit may be a set of information that may be communicated with an application (e.g., at an application layer). For instance, an ADU may correspond to a video frame, where the PDU set is utilized to transmit sets of data corresponding to the video frame.

In some approaches, communication (e.g., transmission or reception), discarding behavior, or prioritization behavior may be performed at a PDU set level of granularity. In some examples, one or more parameters may be utilized for PDU set handling. For instance, one or more parameters may be utilized to satisfy SLA criteria for one or more services (e.g., XR or other services). Examples of the parameters may include a PSIHI, PSDB, PSER, or PSI, among other examples. In some examples, a UE 115 or a network entity 105 may perform PDU set handling, where a group of PDUs may be identified as a PDU set to ensure that transmission and BLER targets are met within a PSDB and a PSER, respectively. For instance, a PSER of 10% may be utilized to trigger discarding a PDU set if more than 10% of the PDUs in the PDU set are received unsuccessfully.

In some examples, PDU set handling may be performed based on one or more PDU set associations between packets for scheduling behavior or discarding behavior from a transmitter perspective. PSI may be utilized to indicate relative priority between PDU sets during one or more scenarios (e.g., for loading or congestion conditions from a transmitter perspective). For instance, PSI may be utilized to discard some traffic in a case of congestion.

In some cases, integrity criteria associated with one or more PDU sets may be utilized as part of PSIHI for discarding behavior from the transmitter perspective or BLER handling from the receiver perspective. For instance, the PSIHI may be utilized to process, deliver, or discard traffic based on whether one or more packets of a PDU set are discarded or lost.

Examples of some PDU set procedures are provided as follows. At the reception of a PDCP SDU from an higher layer(s), a transmitting PDCP entity may perform one or more operations. If a discardTimerForLowImportance is configured and a PSI-based SDU discard procedure is activated, and if the PDCP SDU belongs to a low importance PDU set, the PDCP entity may start the discardTimerForLowImportance associated with the PDCP SDU. Otherwise, the PDCP entity may start a discardTimer associated with the PDCP SDU, if configured. When a successful delivery of a PDCP SDU is confirmed by a PDCP status report, the transmitting PDCP entity may discard the PDCP SDU with a corresponding PDCP data PDU. When the discardTimer or discardTimerForLowImportance expired for a PDCP SDU, the transmitting PDCP entity may discard all PDCP SDUs belonging to the PDU set to which the PDCP SDU belongs with the corresponding PDCP data PDUs if pdu-SetDiscard is configured. Otherwise, the transmitting PDCP entity may discard the PDCP SDU with a corresponding PDCP data PDU. One or more PDCP SDUs that are subsequently received from an upper layer(s) may be discarded if the PDCP SDUs belong to the PDU set. A type of PDCP SDU (e.g., a “delay-critical PDCP SDU”) may be a PDCP SDU for which the remaining time until discardTimer expiry is less than the remaining Time Threshold, if pdu-SetDiscard is not configured, or may be a PDCP SDU belonging to a PDU Set of which at least one PDCP SDU has the remaining time until discardTimer expiry less than the remaining TimeThreshold, if pdu-SetDiscard is configured.

In some approaches, RAN or resource management associated with the RAN may be performed based on one or more PDU set characteristics with the coordinated information between a core network and that RAN (without an explicit indication on the OTA PDUs, for instance). In some examples, a network may determine one or more RRM aspects based on one or more KPI values associated with PDU set performance.

In some cases, rigid PDU set handing (e.g., UE PDU set behavior) may be achieved at a cost of flexibility. For example, PDU set information and relative priority or handling behavior may be left to one or more upper layers based on internal traffic information (which may be coordinated with an application server on the network side). In some aspects, a BSR associated with a PDU set may be utilized to indicate that a burst has not ended (e.g., the non-end of a burst) with a BSR value of 0. In some approaches, PDU set prioritization among outstanding information within a flow may not be defined with different priorities, but may be handled purely in order. PDU set KPIs may be utilized for some functional logics, but may not be utilized for other procedures.

A KPI may be a metric that indicates an aspect of communication performance. For instance, a UE may monitor one or more KPIs to assess performance. Some examples of KPIs may a quantity of discarded PDU sets or a quantity of lost PDU sets, among other examples. In some approaches, PDU set metrics or KPIs may be used to evaluate UE performance, but may not be used to modify any UE specific procedures. Additionally, or alternatively, the PDU set metrics or KPIs may not be communicated (e.g., exchanged) among entities (e.g., UEs and network entities). In uplink communications at a UE, for instance, PDU sets discarded due to PSI, PSIHI, or PSDB procedures may not be indicated to the network. In downlink communications, PDU sets discarded due to PSIHI or PSDB procedures may not be indicated to the network.

In some examples of the techniques described herein, one or more PDU set metrics or KPIs may be communicated between one or more UEs 115 and network entities 105. For instance, a network entity 105 may send configuration information to a UE 115 for configuring the UE 115 to communicate an indication of one or more KPIs associated with one or more PDU sets. The network entity 105 and the UE 115 may communicate the KPI(s). For instance, a UE 115 or network entity 105 may utilize one or more procedures to exchange one or more PDU set KPIs for enhanced coordination (e.g., information sharing) regarding traffic-oriented discarding or OOW behavior to enable changing scheduling patterns for (e.g., for duplication of scheduling patterns for) improved KPI or service enablement. In some examples, the KPI(s) may be utilized to modify the PSIHI, PSDB, PSER, PSI, a cell reselection criterion, a handover criterion, a slice selection, a PDU session, an SR procedure, a RACH procedure, an RLF procedure, a DRX configuration, a MIMO configuration, or other aspect to enhance communication performance.

In some examples, a network entity 105 may send configuration information for configuring a range of a parameter (e.g., PSIHI, PSDB, PSER, or PSI, among other examples) at the UE 115. The UE 115 may select a value from the range of the parameter to enhance communication performance. In some examples, an AI model may be trained or utilized to select the value. In some approaches, a UE 115 may perform one or more operations such as autonomously initiating PDU set handling or influencing PDU set discarding or transmission rules. The one or more operations may be performed based on UE 115 internal information, radio conditions, scheduling patterns, or a current RAN or core network-based PDU set configuration or bearer configuration. The one or more operations may be performed, for example, to improve service to meet an SLA when the outstanding buffers are not drained.

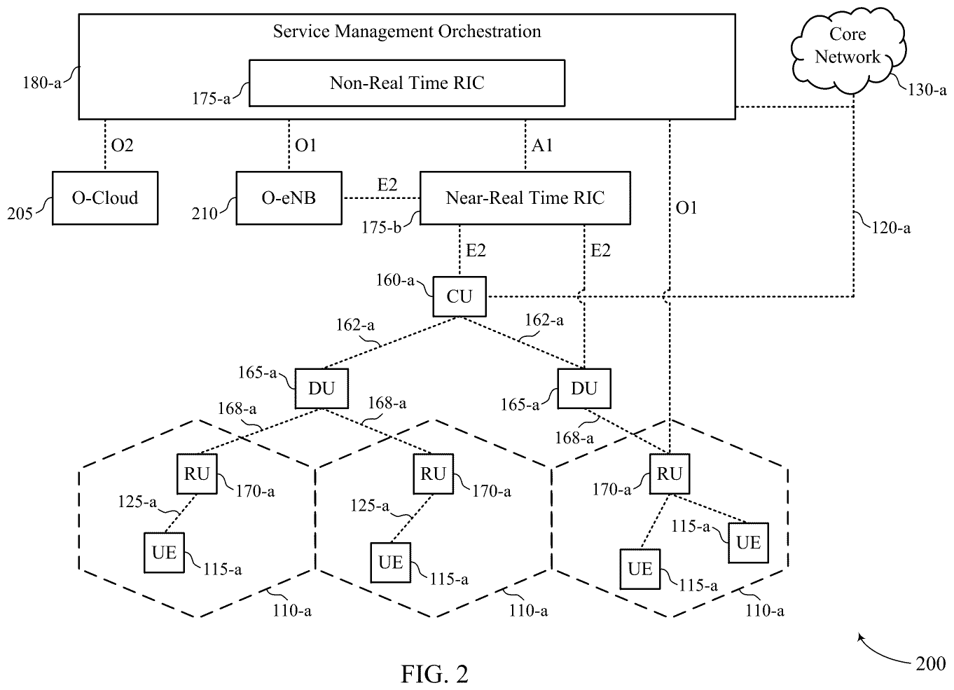

FIG. 2 shows an example of a network architecture 200 (e.g., a disaggregated base station architecture, a disaggregated RAN architecture) that supports configurations for PDU sets in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an AI interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-cNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., AI policies).

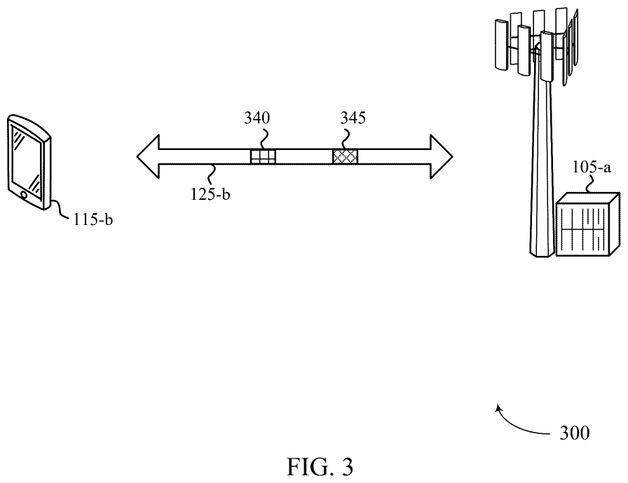

FIG. 3 shows an example of a wireless communications system 300 that supports configurations for PDU sets in accordance with one or more aspects of the present disclosure. In some examples, aspects of the wireless communications system 300 may implement or be implemented by aspects of the wireless communications system 100 or the network architecture 200. For example, the wireless communications system 300 may include a UE 115-b, which may be an example of the UE 115 described with reference to FIG. 1 or the UE 115-a described with reference to FIG. 2. Additionally, or alternatively, the wireless communications system 300 may include a network entity 105-a, which may be an example of the network entity 105 described with reference to FIG. 1.

The UE 115-b may communicate with the network entity 105-a using a link 125-b, which may be an example of a communication link 125 described with respect to FIG. 1 or the communication link 125-a described with reference to FIG. 2. The link 125-b may include a bi-directional link that enables uplink or downlink network communications. For example, the UE 115-b may transmit one or more uplink transmissions, such as uplink control signals or uplink data signals, to the network entity 105-a using the link 125-b, or the network entity 105-a may transmit one or more downlink transmissions, such as downlink control signals or downlink data signals, to the UE 115-b using the link 125-b. As used herein, the term “communication” and variations thereof may denote transmission, reception, or a combination thereof. For example, the UE 115-b may communicate by transmitting a signal to the network entity 105-a, may communicate by receiving a signal from the network entity 105-a, or a combination of both.

The network entity 105-a may output (e.g., send or transmit), or the UE 115-b may receive, configuration information 340 for configuring the UE 115-b to communicate an indication 345 of one or more KPIs associated with one or more PDU sets. For example, the network entity 105-a may configure the UE 115-b with a procedure for PDU set KPI communication or exchange. Each PDU set of the one or more PDU sets may include a plurality of PDUs associated with an ADU for communication between the UE 115-b and a network. For instance, the configuration information 340 may be signaling for requesting or instructing the UE 115-b to communicate the indication 345 of the KPI(s) associated with the PDU set(s).

In some examples, the UE 115-b may communicate the one or more PDU sets (e.g., ADUs) with a network that includes the network entity 105-a or another network. For instance, the network entity 105-a may communicate the PDU set(s) with the UE 115-b. Additionally, or alternatively, the network entity 105-a may communicate the PDU set(s) with one or more UEs (which may include the UE 115-b or one or more other UEs). The UE 115-b or the network entity 105-a may determine (e.g., monitor, measure, track, or record) the KPI(s) based on the PDU set(s). For example, the UE 115-b or the network entity 105-a may track a quantity of discarded or lost (e.g., unsuccessfully communicated) PDU set(s) as a KPI.

The UE 115-b or the network entity 105-a may communicate (e.g., output, transmit, obtain, or receive) the indication 345 of the one or more KPIs associated with the one or more PDU sets based on the configuration information 340. For instance, the UE 115-b or the network entity 105-a may communicate the indication 345 of the one or more KPIs, where the one or more KPIs may be associated with a quantity of lost PDU sets or discarded PDU sets of the one or more PDU sets. In some examples, the UE 115-b may transmit the indication 345 to the network entity 105-a. Additionally, or alternatively, the network entity 105-a may transmit the indication 345 to the UE 115-b.

In some examples, the indication 345 of the one or more KPIs may indicate a first quantity of lost PDU sets associated with a PSIHI criterion, a second quantity of lost PDU sets associated with a discard timer expiration, a third quantity of lost PDU sets associated with a reordering timer expiration, or a combination thereof, among other examples. Additionally, or alternatively, the indication 345 of the one or more KPIs may indicate a first quantity of discarded PDU sets associated with a PSIHI criterion, a second quantity of discarded PDU sets associated with a resource limitation, or a combination thereof, among other examples.

In some approaches, the communication of the indication 345 may be based on the configuration information 340 (e.g., performed in response to the configuration information 340 or performed at least partially in accordance with the configuration information 340). In some examples, the configuration information 340 may indicate an event or a periodic schedule for communicating the indication 345 of the one or more KPIs. The indication 345 of the one or more KPIs may be communicated based on the event or the periodic schedule. For instance, one or more reports of the KPIs may be generated based on an event (e.g., percentage or absolute quantity of PDU set loss) or based on a periodic schedule.

In some aspects, the UE 115-b may perform one or more procedures associated with (e.g., during) PDU set functionality based on one or more PDU set performance KPIs. For instance, the UE 115-b may communicate (e.g., exchange) one or more KPIs or PDU set level metrics periodically or based on one or more events. In some approaches, a periodic timer or event-based communication may be configured by the network entity 105-a. An example of an event may be when a PDU set loss satisfies a threshold (e.g., a PDU set loss is above a count or percentage, such as if 10 PDU sets are lost or 10 percent of PDU sets is lost). In some approaches, the UE 115-b may communicate (e.g., transmit or receive) an indication of one or more lost PDU sets (e.g., PDU set(s) lost in reception) or one or more discarded PDU sets (e.g., PDU set(s) discarded in transmission) for one or more criteria (e.g., congestion criterion, discard criterion, PSIHI criterion, or memory limitation criterion, among other examples).

In some examples, communication of the one or more KPIs may assist the network entity 105-a to improve one or more scheduling aspects or reconfigure the PDU set characteristics. Additionally, or alternatively, the UE 115-b may perform one or more functions or procedures based on the one or more KPIs (e.g., PDCP duplicates or OOW traffic). For instance, the UE 115-b may utilize one or more PDU set performance KPI metrics to determine or influence one or more RAN or core network procedures for enhanced error handling or one or more protocol procedures (e.g., cell reselection, handover, conditional handover, lower-layer triggered mobility (LTM), PDU session initiation, or slice selection, among other examples). Determining or influencing the procedure(s) may achieve reduced delay, improved throughput, or reduced errors for enhancing performance (e.g., satisfying an SLA for a service). One or more of the techniques described herein may be performed in addition to, or alternatively from, other PDU set procedures.

In some approaches, the configuration information 340 may indicate a configuration of medium access control-control element (MAC-CE) signaling, PDCP signaling, or RRC signaling for the indication 345 of the one or more KPIs. The indication 345 of the one or more KPIs may be communicated via the MAC-CE signaling, the PDCP signaling, or the RRC signaling. In some aspects, communicating the indication 345 of the one or more KPIs may be initiated by the UE 115-b (e.g., indicated or requested by the UE 115-b) or the network entity 105-a. In some approaches, the UE 115-b may transmit, or the network entity 105-a may obtain (e.g., receive, a request for the indication 345 of the one or more KPIs via MAC-CE signaling, PDCP signaling, or RRC signaling. For example, one or more KPI reports may be initiated by the UE 115-b or the network entity 105-a, where the KPI report(s) may be communicated via MAC-CE (e.g., at a logical channel (LC) or logical channel group (LCG) level) signaling, via PDCP (e.g., at a radio bearer (RB) level), or via one or more other RRC-based measurement mechanisms (e.g., via a total UE level report, PDU session level report, slice level report, or RB level report with one or more measurement identifier-based triggers).

In some approaches, KPI information associated with one or more PDU sets (e.g., PDU set KPI information) may be expressed as an RRC message to communicate (e.g., exchange) with the network entity 105-a based on an event, a periodic schedule, or in response to a signal (e.g., a PDU set KPI information request). Additionally, or alternatively, the KPI information associated with one or more PDU sets may be expressed as a MAC-CE (e.g., a variant through a MAC-CE) based on a requested PDCP RB, LCG, or PDU session. In some aspects, KPI information associated with one or more PDU sets may be implemented as a part of a MAC-CE or PDCP control PDU. In some examples, PDU set KPI information may be communicated via RRC signaling in accordance with Listing (1).

Listing (1)

```
// PDU Set KPI Info to be exchanged through RRC
PDUSetKPIInformation-IEs ::= SEQUENCE {
      drb-PDUSetKPIInfoList DRB-PDUSetInfoList,
      nonCriticalExtension SEQUENCE { } OPTIONAL
}
DRB-PDUSetInfoList ::= SEQUENCE (SIZE (0..maxDRB)) OF DRB-PDUSetInfo
// PDUSet info in each direction for the given DRB
DRB-PDUSetInfo ::= SEQUENCE {
  drb-Identity DRB-Identity,
  PDUSetInfo-Uplink PDUSetInfo,
  PDUSetInfo-downlink PDUSetInfo,
}
//Number of PDUSets discarded due to below reasons
PDUSetInfo ::= SEQUENCE {
    PDUSetDiscardTimer INTEGER(0..65535)
    PDUSetDiscardIntegrity INTEGER(0..65535)
    PDUSetDiscardImportance INTEGER(0..65535)
    PDUSetDiscardOther INTEGER(0..65535)
}
```

In Listing (1), PDUSetKPIInformation-IEs includes one or more information elements IEs), such as the DRB-PDUSetInfoList. The DRB-PDUSetInfoList may indicate a quantity of one or more data radio bearers (DRBs) corresponding to the PDU set KPI information. The DRB-PDUSetInfo may indicate a DRB-Identity (to identify an associated DRB), PDUSetInfo-Uplink PDUSetInfo (to carry KPI information for one or more PDU sets corresponding to an uplink), or PDUSetInfo-downlink PDUSetInfo (to carry KPI information for one or more PDU sets corresponding to a downlink). The PDUSetInfo may indicate one or more quantities of PDU sets discarded due to timer expiration (e.g., PDUSetDiscardTimer), due to an integrity issue (e.g., PDUSetDiscardIntegrity), due to a priority (e.g., PDUSetDiscardImportance), or for another reason(s) (e.g., PDUSetDiscardOther).

In some examples, the configuration information 340 may indicate a trigger to switch RBs in a PDU session based on a PSDB metric, a PSER metric, a PSI metric (e.g., a congestion-based PSI discard metric trigger), or another quantity, among other examples. For instance, the configuration information 340 may indicate a PSDB, PSER, or PSI metric-based trigger to switch a communication flow from one RB to another RB within a PDU session. The UE 115-b of the network entity 105-a may switch from a first RB to a second RB based on the trigger. In some examples, one or more aspects of switching RBs may be performed in conjunction with, or with some similarly to, reflective quality of service (RQOS) functionality. In some approaches, the UE 115-b may select the trigger (e.g., PSDB, PSER, or PSI metric-based trigger) to switch communication flow from one RB to another RB in a PDU session. In some aspects, the UE 115-b may transmit, or the network entity 105-a may obtain (e.g., receive) an indication of a trigger to switch RBs in a PDU session based on a PSDB, a PSER, or a PSI metric.

In some approaches, the configuration information 340 may indicate a trigger to select a slice or a PDU session based on the indication 345 of the one or more KPIs. For one or more upcoming or new communication flows, for instance, the configuration information 340 may indicate one or more PDU set metrics or KPI-based input to influence a trigger for PDU session or slice selection. Additionally, or alternatively, the configuration information 340 may indicate one or more PDU set metrics or KPI-based input (e.g., PDU set metrics or KPI-based input within a (recent) period of time) to influence one or more new PDU session or slice selection criteria (e.g., UE route selection policy (URSP) rules or a network slice selection assistance information (NSSAI) procedure). For instance, the PDU set metric(s) or KPI-based input may be utilized for telematics for a traffic specific slice or PDU session. The UE 115-b or the network entity 105-a may select a slice or a PDU session based on the trigger, metric(s), or input. In some approaches, the UE 115-b may select one or more PDU set metrics or KPI-based input to influence the trigger for PDU session or slice selection for one or more upcoming or new communication flows. Additionally, or alternatively, the UE 115-b may select one or more PDU set metrics or KPI-based input (e.g., PDU set metrics or KPI-based input within a (recent) period of time) to influence the one or more new PDU session or slice selection criteria (e.g., URSP rules or an NSSAI procedure). In some approaches, the UE 115-b may transmit, or the network entity 105-a may obtain (e.g., receive) information for modifying a trigger to select a slice or a PDU session based on the indication 345 of the one or more KPIs.

In some aspects, the configuration information 340 may indicate a cell reselection criterion or a handover criterion to switch cells based on the indication 345 of the one or more KPIs. For instance, the configuration information 340 may indicate one or more PDU set metrics or KPI-based input (e.g., PDU set metrics or KPI-based input within a (recent) period of time) to influence one or more cell reselection criteria (e.g., to provide additional hysteresis for cell reselection). Additionally, or alternatively, the configuration information 340 may indicate one or more PDU set metrics or KPI-based input (e.g., PDU set metrics or KPI-based input within a (recent) period of time) to influence one or more handover criteria (e.g., through measurements for handover or for triggering one or more conditional handover or LTM conditions). In some examples, the UE 115-b may switch from a first cell to a second cell based on the cell reselection criterion or the handover criterion. In some approaches, the UE 115-b may select one or more PDU set metrics or KPI-based input (e.g., PDU set metrics or KPI-based input within a (recent) period of time) to influence the one or more cell reselection criteria (e.g., to provide additional hysteresis for cell reselection). Additionally, or alternatively, the UE 115-b may select one or more PDU set metrics or KPI-based input (e.g., PDU set metrics or KPI-based input within a (recent) period of time) to influence the one or more handover criteria (e.g., through measurements for handover or for triggering one or more conditional handover or LTM conditions). In some approaches, the UE 115-b may transmit, or the network entity 105-a may obtain (e.g., receive) information for modifying a cell reselection criterion or a handover criterion to switch cells based on the indication 345 of the one or more KPIs.

In some examples, the UE 115-b may select one or more PDU set metrics or KPI-based input (e.g., PDU set metrics or KPI-based input within a (recent) period of time) to influence an SR, RACH, or RLF procedure (e.g., to conclude an SR, RACH, or RLF procedure earlier or later than configured). The UE 115-b may transmit, or the network entity 105-a may obtain (e.g., receive) information for modifying an SR procedure, a RACH procedure, or an RLF procedure based on the indication 345 of the one or more KPIs.

In some examples, the UE 115-b may select one or more PDU set metrics or KPI-based input (e.g., PDU set metrics or KPI-based input within a (recent) period of time) to indicate a target DRX configuration, bandwidth configuration, MIMO configuration, or other configuration. For instance, the UE 115-b may transmit, or the network entity 105-a may obtain (e.g., receive) an indication of a DRX configuration, a bandwidth configuration, or a MIMO configuration via RRC UAI signaling based on the indication 345 of the one or more KPIs.

In some approaches, an artificial intelligence or machine learning (AI/ML) model may be trained based on the one or more KPIs associated with the one or more PDU sets. The AI model may trained or utilized at the UE 115-b, the network entity 105-a, or at another device based on one or more monitored KPIs.

In some examples, the UE 115-b may monitor one or more PDU set KPI metrics. In a downlink, for instance, the UE 115-b may monitor one or more of the following quantities: a quantity of PDU sets missed due to a reordering expiration-based window movement, a quantity of PDU sets discarded due to PSIHI criteria with at least one missing PDU in the set, a quantity of PDU sets duplicated in downlink due to PDCP duplication, or a quantity of PDU sets discarded due to memory-based issues (e.g., issues with a bursty scheduling pattern in a modem, where some XR chipsets may have significant memory restrictions), among other examples. In an uplink, the UE 115-b may monitor one or more of the following quantities: a quantity of PDU sets discarded due to delays in scheduling resulting in PDCP discard timer expiration, a quantity of PDU sets discarded due to a PSI based mechanism (e.g., due to congestion), a quantity of PDU sets discarded due to memory-based issues (e.g., issues with a traffic pattern in a modem), or a quantity of PDU sets duplicated due to scheduling or reliability issues across uplink links (e.g., reliability issues due to PDCP duplication with a split bearer, where imbalanced scheduling across links may occur), a quantity of instances that one or more procedures were triggered for refinement of the handover procedures (e.g., where the UE 115-b has influenced conditional handover or LTM aspects based on the PDU set KPI), or a quantity of instances of data status report (DSR) or a BSR enhancement (e.g., where the UE 115-b has influenced an enhancement to DSR or BSR metrics for downlink or uplink scheduling), among other examples.

One or more of the aforementioned quantities (e.g., metrics or KPIs) may be utilized for training an AI/ML model for use at the UE 115-b to refine UE-based PDU set handling procedures. Additionally, or alternatively, one or more of the aforementioned quantities may be communicated (e.g., reported) to the network entity 105-a for AI/ML model training to select a configuration of PDU set characteristics or scheduling or grant patterns.

In some examples, the UE 115-b or the network entity 105-a may execute an AI/ML model based on the one or more KPIs. For instance, the AI/ML model may be executed to set a timer associated with a PDU set, to select a PSI level, or to select a congestion procedure, among other examples. In some approaches, based on the AI/ML model, the UE 115-b may select (e.g., autonomously select) one or more different values for the PDU set related timers (e.g., a discard timer), a PSI level, or congestion handling mechanisms. In some aspects, the UE 115-b may prioritize a flow of one or more PDU sets ahead of one or more other PDU sets within an RB based on an inter-flow relation. The UE 115-b may skip some one or more PDU sets or change a traffic pattern to influence a grant pattern or power aspects of the UE 115-b. The UE 115-b may influence RLC behavior, MAC behavior, conditional handoff aspects, LTM aspects, or cell reselection aspects to improve one or more PDU set KPIs based on one or more of the aforementioned quantities.

In some examples, the UE 115-b may transmit, or the network entity 105-a may receive, capability information (not shown in FIG. 2) indicating a capability of the UE 115-b to communicate the indication 345 of the one or more KPIs associated with the one or more PDU sets. In some approaches, the capability information may indicate a capability to communicate (e.g., exchange) one or more PDU set level metrics from a downlink perspective. For instance, the capability information may indicate a capability to communicate one or more lost PDU sets (e.g., unsuccessfully received PDU set(s)) due to one or more PSIHI criteria with one or more missing packets, one or more lost PDU sets due to a discard timer expiration (at a DU level with a scheduling issue, for example), or a complete PDU set loss due to a reordering timer expiration (in BLER conditions or scheduling delays in a carrier aggregation (CA) case or a dual carrier (DC) case, among other examples).

In some aspects, the capability information may indicate a capability to communicate (e.g., exchange) PDU set level metrics from an uplink perspective, such as one or more discarded PDU sets (e.g., discarded from transmission) for one or more criteria (e.g., congestion criterion, discard criterion, PSIHI criterion, or memory limitation criterion, among other examples). In some examples, communication of the one or more KPIs may assist the network entity 105-a to improve one or more scheduling aspects or reconfigure the PDU set characteristics. In some approaches, the UE 115-b or the network entity 105-a may communicate the indication 345 in accordance with the capability information.

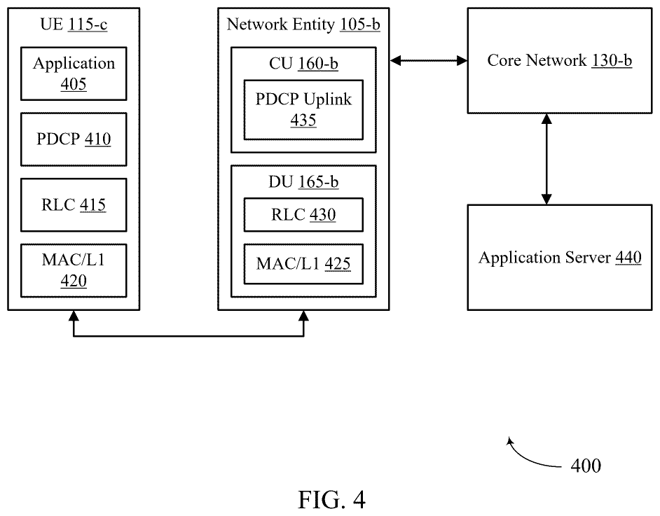

FIG. 4 is a block diagram illustrating examples of devices 400 that support configurations for PDU sets in accordance with one or more aspects of the present disclosure. FIG. 4 illustrates an example of a UE 115-c, a network entity 105-c, a core network 130-b, and an application server 440. The UE 115-c may be an example of the UE 115 described with reference to FIG. 1, the UE 115-a described with reference to FIG. 2, or the UE 115-b described with reference to FIG. 3. The network entity 105-a may be an example of the network entity 105 described with reference to FIG. 1 or the network entity 105-a described with reference to FIG. 3. The network entity 105-b may include a CU 160-b and a DU 165-b. The CU 160-b may be an example of the CU 160 described with reference to FIG. 1 or the CU 160-a described with reference to FIG. 2. The DU 165-b may be an example of the DU 165 described with reference to FIG. 1 or the DU 165-a described with reference to FIG. 2.

The core network 130-b may be an example of the core network 130 described with reference to FIG. 1 or the core network 130-a described with reference to FIG. 2. The application server 440 may be a computing device for providing one or more services to the UE 115-c. For instance, the application server 440 may include hardware or a combination of hardware and instructions to communicate with, or provide services to, the UE 115-c via the core network 130-b or the network entity 105-b.

In some examples, the UE 115-c or the network entity 105-b may utilize one or more layers of operation. The layers of operation may correspond to layers of the open systems interconnection (OSI) model or layers of one or more protocols, among other examples. In the example of FIG. 4, the UE 115-c includes an application layer 405, a PDCP layer 410, an RLC layer 415, and a MAC/L1 layer 420. The CU 160-b may include a PDCP uplink layer 435. The DU 165-b may include an RLC layer 430 and a MAC/L1 layer 425.

Without the techniques described herein, KPI information may not be communicated between devices 400. For instance, different devices may lack KPI information to indicate whether PDUs have been lost or discarded. For instance, if uplink packets are dropped between the application layer 405 and the PDCP layer 410 of the UE 115-c, the network entity 105-b (e.g., CU 160-b or DU 165-b) may not have information indicating that a block error occurred (due to a PDCP number not being assigned, for instance). If downlink packets are discarded between the core network 130-b and the network entity 105-b, the UE 115-c may not have information indicating that the discard occurred, and may be prevented from making one or more adjustments to improve communication.

In accordance with some of the techniques described herein, PDU set KPI information may be shared between devices 400. For instance, if one or more PDU sets are lost at the UE 115-c due to a timer expiration or integrity issue, the KPI information captured at the UE 115-c may indicate the lost PDUs and may be communicated to the network entity 105-b or core network 130-b. The network entity 105-b or core network 130-b may adjust one or more communication aspects (e.g., scheduling) to enhance communication performance (e.g., to reduce discarded or lost PDU sets). In another example, if one or more PDU sets are discarded at the network entity 105-b due to congestion, the KPI information captured at the network entity 105-b may indicate the lost PDUs and may be communicated to the UE 115-c. The 115-c may influence one or more communication aspects (e.g., scheduling) to enhance communication performance (e.g., to reduce discarded or lost PDU sets).

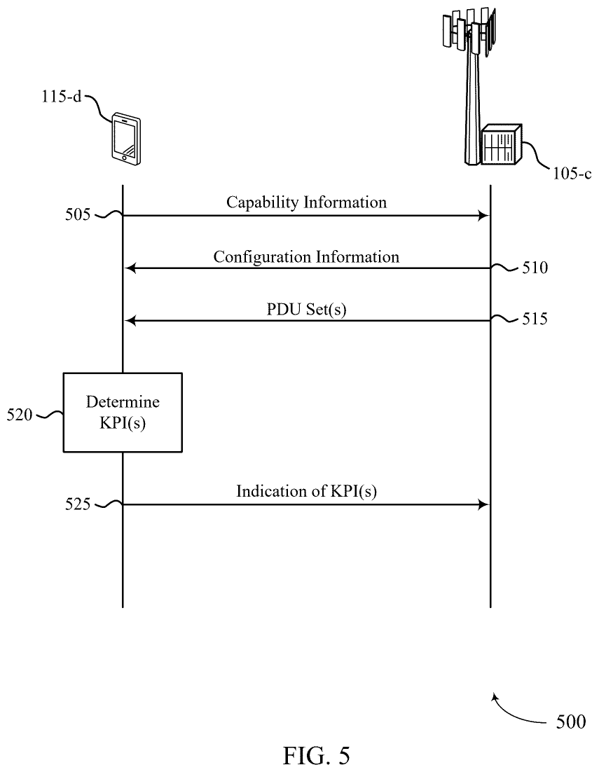

FIG. 5 shows an example of a process flow 500 that supports configurations for PDU sets in accordance with one or more aspects of the present disclosure. In some examples, aspects of the process flow 500 may implement or be implemented by aspects of the wireless communications system 100, the network architecture 200, the wireless communications system 300, or the devices 400. For example, the process flow 500 may be implemented by a UE 115-d or a network entity 105-c, which may be examples of one or more corresponding devices as described herein with reference to FIG. 1, FIG. 2, FIG. 3, or FIG. 4. In the following description of the process flow 500, the operations between the network entity 105-c and the UE 115-d may be performed in a different order than the example order shown in some examples. In some approaches, one or more operations may be omitted from the process flow 500 or added to the process flow 500. Although some operations or signaling may be shown to occur at different times for discussion purposes, these operations may actually occur at the same time in some examples.

At 505, the UE 115-d may send (e.g., transmit), or the network entity 105-c may obtain (e.g., receive), capability information. For instance, the capability information may be communicated as described with reference to FIG. 3.

At 510, the network entity 105-c may output (e.g., send), or the UE 115-d may receive, configuration information. For instance, the configuration information may be communicated as described with reference to FIG. 3.

At 515, the network entity 105-c may output (e.g., send), or the UE 115-d may receive, one or more PDU sets. For instance, the PDU set(s) may be communicated as described with reference to FIG. 3.

At 520, the UE 115-d may determine one or more KPI(s). For instance, the UE 115-d may record or determine KPI information (e.g., quantities of discarded or lost PDU sets) as described with reference to FIG. 2.

At 525, the UE 115-d may send (e.g., transmit), or the network entity 105-c may obtain (e.g., receive), an indication of the KPI(s). For instance, the indication of the KPI(s) may be communicated as described with reference to FIG. 3.

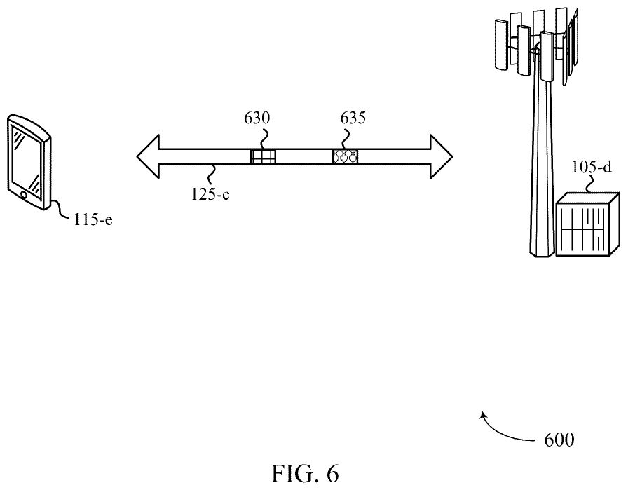

FIG. 6 shows an example of a wireless communications system 600 that supports configurations for PDU sets in accordance with one or more aspects of the present disclosure. In some examples, aspects of the wireless communications system 600 may implement or be implemented by aspects of the wireless communications system 100 or the network architecture 200. For example, the wireless communications system 600 may include a UE 115-e, which may be an example of the UE 115 described with reference to FIG. 1 or the UE 115-a described with reference to FIG. 2. Additionally, or alternatively, the wireless communications system 600 may include a network entity 105-d, which may be an example of the network entity 105 described with reference to FIG. 1. In some examples, one or more aspects of the UE 115-b described with reference to FIG. 3, the UE 115-c described with reference to FIG. 4, or the UE 115-d described with reference to FIG. 5 may be implemented in combination with one or more aspects of the UE 115-e. Additionally, or alternatively, one or more aspects of the network entity 105-d described with reference to FIG. 3, the network entity 105-b described with reference to FIG. 4, or the network entity 105-c described with reference to FIG. 5 may be implemented in combination with one or more aspects of the UE 115-e.

The UE 115-e may communicate with the network entity 105-d using a link 125-c, which may be an example of a communication link 125 described with respect to FIG. 1 or the communication link 125-a described with reference to FIG. 2. The link 125-c may include a bi-directional link that enables uplink or downlink network communications. For example, the UE 115-e may transmit one or more uplink transmissions, such as uplink control signals or uplink data signals, to the network entity 105-d using the link 125-c, or the network entity 105-d may transmit one or more downlink transmissions, such as downlink control signals or downlink data signals, to the UE 115-e using the link 125-c. For example, the UE 115-e may communicate by transmitting a signal to the network entity 105-d, may communicate by receiving a signal from the network entity 105-d, or a combination of both.

The network entity 105-d may output (e.g., send or transmit), or the UE 115-e may receive, configuration information 630 for configuring a range for at least one parameter associated with one or more PDU sets 635. Each PDU set of the one or more PDU sets 635 may include PDUs associated with an ADU for communication between the UE 115-e and a network. In some examples, the at least one parameter associated with the one or more PDU sets 635 may include a PSI level, a PSIHI criterion, a trigger associated with a PSDB, a priority associated with a PSDB, a RACH factor associated with a PSDB, a threshold associated with a PSDB, or a combination thereof, among other examples.

In some examples, the UE 115-e or the network entity 105-d may perform PDU set handling, where a group of PDUs may be identified as a PDU set to ensure that transmission and BLER targets are met within a PSDB and a PSER, respectively. PSI may be utilized to discard some traffic in a case of congestion. PSIHI may be utilized to process, deliver, or discard traffic based on whether one or more packets of a PDU set are discarded or lost.

The range for the at least one parameter may allow the UE 115-e to select a value within the range for operation. For example, the network entity 105-d may configure the UE 115-e with a flexible procedure based on internal information at the UE 115-e (which may be derived from one or more AI/ML aspects).

In some examples, when the traffic on a given RB is below a remaining PSDB threshold, one or more LC parameters may be configured by the network (e.g., the network entity 105-d). For instance, a flexible range for a parameter may be configured, where a value may be selected by the UE 115-e. In some aspects, the UE 115-e may select the value based on AI/ML, information regarding radio conditions or a traffic pattern varying with time and a UE 115-e model. In some examples, each range may be indicated using a minimum and a maximum value for the range. Examples of ranges for various parameters are indicated in Listing (2).

Listing (2)

| | |
|---|---|
| RemainingPSDBLCPriority-min | LCPriority |
| RemainingPSDBLCPriority-max | LCPriority |
| RemainingPSDBsr-ProhibitTimer-min | Bsr-ProhibitTimer |
| RemainingPSDBsr-ProhibitTimer-max | Bsr-ProhibitTimer |
| RemainingPSDBperiodicBSR-Timer-min | periodicBSR-Timer |
| RemainingPSDBperiodicBSR-Timer-max | periodicBSR-Timer |
| RemainingPSDBretxBSR-Timer-min | retxBSR-Timer |
| RemainingPSDBretxBSR-Timer-max | retxBSR-Timer |

RemainingPSDBlogicalChannelSR-DelayTimer-min logicalChannelSR-
DelayTimer
RemainingPSDBlogicalChannelSR-DelayTimer-max logicalChannelSR-
DelayTimer
//powerRampingStep: the RACH power-ramping factor
RemainingPSDBpowerRampingStep-min powerRampingStep
RemainingPSDBpowerRampingStep-max powerRampingStep
//msgA-PreamblePowerRampingStep: the power ramping factor for MSGA
preamble
msgA-PreamblePowerRampingStep-min powerRampingStep
msgA-PreamblePowerRampingStep-min powerRampingStep

In Listing (2), RemainingPSDBLCPriority-min and RemainingPSDBLCPriority-max may indicate an example of a range for a priority associated with a PSDB. RemainingPSDBsr-ProhibitTimer-min, RemainingPSDBsr-ProhibitTimer-max, RemainingPSDBperiodicBSR-Timer-min, RemainingPSDBperiodicBSR-Timer-max, RemainingPSDBretxBSR-Timer-min, RemainingPSDBretxBSR-Timer-max, RemainingPSDBlogicalChannelSR-DelayTimer-min, or RemainingPSDBlogicalChannelSR-DelayTimer-max, may indicate examples of ranges for one or more triggers associated with a PSDB. RemainingPSDBpowerRampingStep-min, RemainingPSDBpowerRampingStep-max, msgA-PreamblePowerRampingStep-min, or msgA-PreamblePowerRampingStep-max may indicate examples of ranges for a RACH factor associated with a PSDB.

When the traffic on a given RB is below a remaining PSDB threshold, an RLC channel may temporarily have network-configured poll or status parameters as indicated in Listing (3).

Listing (3)

| | |
|---|---|
| RemainingPSDBPollPDU-min | PollPDU, |
| RemainingPSDBPollPDU-max | PollPDU, |
| RemainingPSDBPollByte-min | PollByte, |
| RemainingPSDBPollByte-max | PollByte, |

RemainingPSDBStatusProhibit-min T-StatusProhibit,
RemainingPSDBStatusProhibit-max T-StatusProhibit,

In Listing (3), RemainingPSDBPollPDU-min, RemainingPSDBPollPDU-max, RemainingPSDBPollByte-min, RemainingPSDBPollByte-max, RemainingPSDBStatusProhibit-min, or RemainingPSDBStatusProhibit-max may be examples of ranges for parameters associated with a PSDB. One or more ranges may be utilized in addition to, or alternatively from one or more parameters with set individual values (e.g., LCPriority, Bsr-PRohibitTimer, periodicBSR-Timer, retxBSR-Timer, logical ChannelSR-DelayTimer, or powerRampingStep, among other examples).

In some approaches, the configuration information 630 may configure the UE 115-e to perform flexible handling of the PSI based discard during congestion based on the internal UE 115-e traffic characteristics (e.g., memory, million instructions per second (MIPS), or relative traffic importance relativity, among other examples). The range for the PSI level may allow flexibility (rather than being limited to a single value indicated from a network, for instance). For example, the UE 115-c may dynamically select a parameter value from the range based on varying radio scheduling, internal protocol information, or multi-modal aspects of relative priorities between flows.

In some approaches, the configuration information 630 may configure the UE 115-c to perform flexible handling of PSIHI-based discard (during a transmission mode, for example) based on coordinated information (with an application) or other internal information (e.g., payload inspection in hardware or de-packetization hardware support). In some examples, FEC may be implemented flexibly based on the range for PSIHI. For instance, the UE 115-e may autonomously determine to drop the one or more parity packets when all payload (e.g., systematic) packets are delivered successfully. Additionally, or alternatively, the UE 115-e may have application-level information indicating that FEC is being performed at the application layer and may determine to keep a PDU set by selecting a parameter value for the PSIHI to avoid discarding all of the PDU set if a quantity of PDUs were lost.

In some approaches, the configuration information 630 may configure the UE 115-e to perform flexible handling of PSIHI-based reassembly (during a reception mode, for instance) based on coordinated information (with an application) or other internal information (e.g., payload inspection in hardware or de-packetization hardware support). In some examples, FEC may be implemented flexibly based on the range for PSIHI. For instance, the UE 115-e may autonomously determine to drop the one or more parity packets when all payload (e.g., systematic) packets are delivered successfully. Additionally, or alternatively, the UE 115-e may have access to real-time transport control protocol (RTCP) packet headers, which may indicate that there is sufficient redundancy in the PDU set to keep a PDU set by selecting a parameter value for the PSIHI to avoid discarding all of the PDU set if a quantity of PDUs were lost.

In some approaches, the configuration information 630 may configure the UE 115-e to perform prioritization based on PSDB. For instance, traffic (e.g., one or more PDU sets) with remaining PSDB-based priority may ensure that the traffic (e.g., PDU set(s)) gets priority over another communication flow (e.g., high priority flow). In some examples, the prioritization may not depend on a DSR based trigger to the network entity 105-d for a grant (e.g., the grant may be based on a priority of the LC order or may not be based on a delay order of the LCs). The UE 115-e may be enabled to flexibly change or interpret priority based on internal information. For instance, the UE 115-e may flexibly determine to prioritize audio frames over video frames.

In some approaches, the configuration information 630 may configure the UE 115-e to influence polling or status triggers or retransmission at lower layers. For instance, the UE 115-e may determine remaining PSDB-based triggers to influence polling or status triggers or retransmission at lower layers.

In some approaches, the configuration information 630 may configure the UE 115-e to determine a BSR trigger, DSR trigger, or other protocol aspect(s). For instance, the UE 115-e may determine a remaining PSDB-based override of the BSR or DSR triggers and protocol aspects of the procedure, which may allow the UE 115-e to influence the network entity 105-d to provide a grant (e.g., by sending a BSR trigger or DSR trigger before a periodic time).

In some approaches, the configuration information 630 may configure the UE 115-e to influence an SR, RACH trigger, or other protocol aspect(s). For instance, the UE 115-e may determine a remaining PSDB-based override of the SR or RACH triggers and protocol aspects of the procedure (e.g., may perform an earlier SR attempt than provided by an SRDelay timer, or transmit with a higher power ramp step during a RACH procedure or with a modified RACH backoff timer).

The UE 115-e or the network entity 105-d may communicate (e.g., output, transmit, obtain, or receive) the one or more PDU sets 635 (e.g., ADUs) based on the configuration information 630. The one or more PDU sets 635 may be communicated based on a value selected from the range for the at least one parameter associated with the one or more PDU sets 635.

In some examples, UE-based flexible procedures during PDU set handling may be utilized. In some approaches, UE 115-e behavior may be adapted based on an AI/ML model (e.g., scheduler). For instance, the UE 115-e may determine (e.g., autonomously determine) or influence one or more PDU set oriented timers, error handling, or protocol procedures, which may improve one or more PDU set performance metrics (e.g., in terms of delay, error, throughput, or satisfaction of an SLA).

In some approaches, the UE 115-e may execute an AI/ML model to select a value from the range for the at least one parameter. A quantity of the one or more PDU sets 635 may be discarded from the communication with the network entity 105-d based on the value that is selected from the range for the at least one parameter. In some examples, the quantity of the one or more PDU sets 635 may be discarded based on the at least one parameter that includes a PSI level, and based on a resource schedule associated with the one or more PDU sets 635, protocol information associated with the one or more PDU sets 635, multi-modal information associated with the one or more PDU sets 635, frame information associated with the one or more PDU sets 635, or a combination thereof, among other examples. For instance, the UE 115-e may perform flexible handling of the PSI-based discard during congestion, based on one or more internal UE 115-e traffic characteristics (e.g., memory usage, MIPS usage, or relative traffic importance, among other examples). In some aspects, the value of the parameter may be selected from the range to avoid being limited to a single value from a network indication. The flexible handling may be dynamic behavior based on varying radio scheduling, internal protocol information, or one or more multi-modal aspects of relative priorities between flows. Additionally, or alternatively, the flexible handling may be based on information of a frame from processing or inspecting packets (e.g., RTP headers) in hardware (e.g., hardware accelerators). In some aspects, the behavior adaptation may be performed addition to one or more other PDU set procedures.

In some examples, the quantity of the one or more PDU sets 635 may be discarded based on the at least one parameter that includes a PSIHI criterion, and based on application information associated with the one or more PDU sets 635, frame information associated with the one or more PDU sets 635, or a combination thereof, among other examples. For instance, the UE 115-e may perform flexible handling of the PSIHI-based discard (during transmission, for instance) based on coordinated information (with an application) or other internal information. For instance, the flexible handling may be performed based on payload inspection in hardware (e.g., hardware accelerators), packetization hardware support, or traffic type (e.g., payload, systematic, or parity) utilizing RTP or RTCP information, among other examples.

In some aspects, the UE 115-e may execute an AI/ML model to select the value from the range for the at least one parameter that includes a PSIHI criterion. The one or more PDU sets 635 may be reassembled from the communication with the network entity 105-d based on the value that is selected from the range, payload information associated with the one or more PDU sets 635, a type of traffic associated with the one or more PDU sets 635, or a combination thereof, among other examples. For instance, the UE 115-e may perform flexible handling of the PSIHI-based reassembly (during a reception procedure, for example) based on coordinated information (with an application) or other internal information. For instance, the flexible handling may be performed based on payload inspection in hardware (e.g., hardware accelerators), de-packetization hardware support, or traffic type (e.g., payload, systematic, or parity) utilizing RTP or RTCP information, among other examples.

In some examples, the UE 115-e may execute an AI/ML model to select the value from the range for the at least one parameter that is associated with a PSDB or a PSI level. The one or more PDU sets 635 may be prioritized based on the value that is selected from the range. For instance, the UE 115-e may perform one or more remaining PSDB-based priority enhancements (e.g., adjusting a prioritized bit rate (PBR) or bucket size duration (BSD)) during an LCP procedure(s) to ensure that the traffic gets higher priority (e.g., weighted or absolute priority) over one or more other flows. In some aspects, performing the PSDB-based priority adjustment may be performed without depending on a DSR or a BSR-based trigger to the network entity 105-d for a grant.

In some approaches, the one or more PDU sets 635 may be prioritized to override a configuration parameter associated with a BSR or a DSR, may be prioritized for one or more packets during a retransmission, or may be prioritized to override a configuration parameter associated with an SR or a RACH procedure. For instance, the UE 115-e may perform one or more UE-based flexible procedures during PDU set handling. In some examples, the UE 115-c may perform one or more remaining PSDB-based priority enhancements to override one or more configuration parameters of BSR (e.g., a retransmission BSR timer for an expedited retransmission of a BSR to the network entity 105-d) or DSR (e.g., one or more timers associated with DSR threshold-based transmission). In some cases, the UE 115-e may select a remaining PSDB or PSI-based priority to prioritize one or more packets over one or more other packets during an RLC retransmission. Additionally, or alternatively, the UE 115-e may perform one or more remaining PSDB-based priority enhancements to override one or more configuration parameters of an SR procedure (e.g., an SR prohibit timer or a maximum quantity of SR transmissions, among other examples) or a RACH procedure (e.g., RACH preamble power, a quantity of RACH transmissions before reporting an RLF, among other examples).

In some examples, the UE 115-e may execute an AI/ML model to select the value from the range for the at least one parameter that is associated with a PSDB or a PSI level for modifying an RLC level trigger, for modifying a retransmission procedure at a layer that is lower than the RLC level, for modifying a resource for communicating the one or more PDU sets 635, or for reserving power. For instance, the UE 115-e may select one or more remaining PSDB-based triggers to influence RLC level polling or status triggers or retransmission at one or more lower layers. Additionally, or alternatively, the UE 115-e may utilize a remaining PSDB or PSI to influence the leg on which packets are transmitted or to reserve power with a UE 115-e internal mechanism to satisfy a maximum permissible exposure (MPE) target. In some aspects, based on the AI/ML model, the UE 115-e may select (e.g., autonomously select) an approach for handling one or more PDU set configuration parameters (e.g., RLC retransmission trigger(s), poll trigger(s), status trigger(s), MAC LCP trigger(s), MAC BSR trigger(s), MAC DSR trigger(s), PHY layer HARQ, or power characteristics, among other examples) and influencing one or more lower layers. Selecting an approach to handling the one or more PDU set configuration parameters may be performed to improve PDU set performance KPIs based on information such as radio conditions, traffic patterns, scheduling pattern, loading pattern, or cell capabilities.

In some approaches, the value selected from the range may modify a power limitation procedure, CSI reporting, adaptive receive diversity (ARD), or a combination thereof, among other examples. For instance, the UE 115-e may select (e.g., autonomously select) an approach to handle one or more power restrictions (e.g., power restrictions for a SmartTx mechanism) to meet an MPE target with one or more other concurrent services (e.g., voice over new radio (VoNR)), where some other traffic may be reduced. SmartTx may refer to dividing a total transmit power between different entities (e.g., RATs) or reducing power to ensure that a total power over a period of time is within a limit to meet an MPE target or to meet one or more quality targets (e.g., a voice bearer continues to get reserved power). In some examples, the UE 115-c may influence (e.g., autonomously influence) the CSI reported to the network or a UE-internal ARD mechanism, which may influence an uplink grant pattern or downlink scheduling aspects (to improve throughput or latency KPIs relative to power savings, for instance). In some examples, a network model (e.g., AI/ML model) may influence the uplink grant pattern, DRX configuration, downlink scheduling pattern or communication flow, which may implicate one or more of RB mapping, LC priority, LCP configuration (e.g., PBR or BSD) or RQOS aspects.

In some approaches, the UE 115-e may monitor one or more KPIs associated with at least one PDU set (e.g., PDU set KPI metric(s)). The UE 115-e may train an AI/ML model based on the one or more KPIs, where the AI model may be trained to select the value from the range for the at least one parameter. For instance, one or more metrics or KPIs may be utilized for training the AI/ML model. The training may be performed to enhance UE-based PDU set triggered procedures. In some examples, the metric(s) or KPI(s) may be reported to the network entity 105-d for model training (to select a configuration, for instance, such as a best-performing AI/ML configuration).

In some examples, the one or more KPIs may indicate a first quantity of PDU sets 635 that are discarded due to a scheduling issue, a second quantity of PDU sets 635 that are discarded due to network congestion, a third quantity of PDU sets 635 that are discarded due to timer expiration, a fourth quantity of PDU sets 635 that are discarded due to a power limitation, or a combination thereof, among other examples. The AI model may be trained to select the value from the range based on the first quantity, the second quantity, the third quantity, the fourth quantity, or a combination thereof, among other examples.

In some approaches, the UE 115-e may monitor one or more quantities. Examples of the quantities may include a quantity of instances where a PDU set discard timer has expired or PDU set discard statistics (e.g., total bytes corresponding to a discarded PDU set(s) or a quantity of PDU sets). The quantity of discard timer expirations or the PDU set discard statistics may indicate an issue with an instantaneous versus average grant pattern that may impact which frames are lost (e.g., relatively large video frames versus relatively small audio frames based on total bytes rather than a quantity of PDU sets or I-frame loss compared to P-frame loss within a video stream).

Another example of a quantity may include a quantity of instances in an uplink that a PDU set is discarded due to scheduling issues or due to a higher priority LC occupying an uplink grant. The quantity of PDU set discards may indicate an issue with an LCP mechanism or communication flow, which may imply an issue with RB mapping aspects, potential improvement via enhanced RQOS, potential improvement with AS level configuration or the UE 115-e changing (e.g., autonomously changing) an LC priority.

Another example of a quantity may include a quantity of PDU set discards in an uplink due to a congestion indication or timer expiration (e.g., due to a congestion indication versus timer expiration). For instance, a scheduling pattern may result in a PDU set loss due to a loaded cell, edge cell coverage, based on a UE 115-e channel state information (CSI) report (e.g., transmission influenced due to SmartTx) or due (e.g., purely due) to network congestion (with relatively good coverage and channel capacity, for example). Based on the quantity of PDU set discards, the UE 115-e may change PDU set handling or an associated radio trigger(s), counter(s), or timer(s).

In an uplink, a quantity of PDU set discards due to power restrictions may be monitored (e.g., discards due to a SmartTx mechanism or to satisfy an MPE target or a power headroom report (PHR) issue). Based on the quantity of PDU set discards, the UE 115-e may change a PSI-based discard policy or may indicate the congestion to the network entity 105-d.

In some approaches, the one or more KPIs may indicate a first quantity of PDU sets that are discarded due to a reordering timer expiration, a second quantity of PDU sets that are missing due to a PSI level, a scheduling pattern of PDU sets, or a combination thereof, among other examples. The AI/ML model may be trained to select the value from the range based on the first quantity, the second quantity, the scheduling pattern, or a combination thereof, among other examples. Another example of a quantity may include a quantity of instances where a PDU set in a downlink procedure is discarded due to a reordering timer expiration (which may indicates a non-convergence of the RLC automatic repeat request (ARQ) in a time period due to one or more scheduling issues at the radio, due to one or more RLC reassembly timer kinds of configuration issues, due to scheduling issues between a master cell group (MCG) and secondary cell group (SCG), or due to CA aspects such as new radio-dual carrier (NR-DC) aspects. For instance, the quantity of PDU set discards due to a reordering timer expiration may indicate one or more issues with a non-optimal configuration between a quality of service (QoS) class identifier (QCI) delay budget, versus a reordering timer, versus a reassembly timer, or versus a HARQ retransmission conclusion. For example, these issues may occur with VoNR real-time transport protocol (RTP) issues due to incorrect PDCP or RLC timers or a HARQ scheduling pattern.

Another example of a quantity may include a quantity of instances where a PDU set is missing in a downlink due to a PSI-based discard on the network side (to influence the UE-reported receive antenna or CSI metrics, for instance). For instance, a UE ARD mechanism may transition to a lower antenna configuration on the UE 115-c to save power via an indication through CSI. In some cases, the ARD mechanism or an antenna configuration may be disabled temporarily.

Another example of a quantity may include, based on an uplink, a downlink PDU set discard(s) or scheduling pattern. For instance, the UE 115-e may influence a DRX state machine to maintain an “on” state for a time period with one or more dummy transmission to delay an “inactivity” state. In some approaches, dummy traffic or an RLC status PDU may be induced, which may be a mechanism for one or more types of traffic (e.g., video call) to influence the DRX behavior.

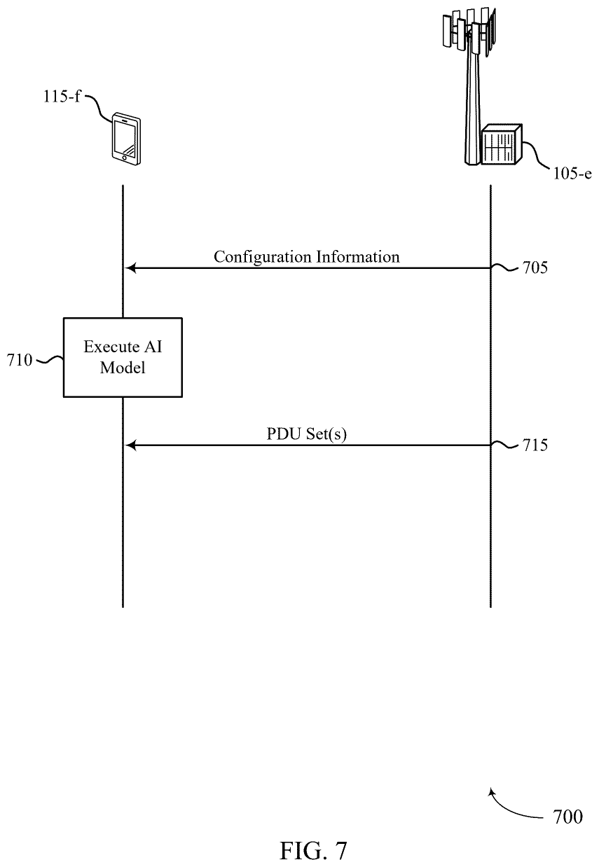

FIG. 7 shows an example of a process flow 700 that supports configurations for PDU sets in accordance with one or more aspects of the present disclosure. In some examples, aspects of the process flow 700 may implement or be implemented by aspects of the wireless communications system 100, the network architecture 200, or the wireless communications system 600. For example, the process flow 700 may be implemented by a UE 115-f or a network entity 105-e, which may be examples of one or more corresponding devices as described herein with reference to FIG. 1, FIG. 2, FIG. 4, or FIG. 6. In the following description of the process flow 700, the operations between the network entity 105-e and the UE 115-f may be performed in a different order than the example order shown in some examples. In some approaches, one or more operations may be omitted from the process flow 700 or added to the process flow 700. Although some operations or signaling may be shown to occur at different times for discussion purposes, these operations may actually occur at the same time in some examples.

At 705, the network entity 105-e may output (e.g., send), or the UE 115-f may receive, configuration information. For instance, the configuration information may be communicated for configuration a range for at least one parameter as described with reference to FIG. 6.

At 710, the UE 115-f may execute an AI model. For instance, the AI model may be executed to select a value from the range as described with reference to FIG. 6.

At 715, the network entity 105-e may output (e.g., send), or the UE 115-f may receive, one or more PDU sets. For instance, the PDU set(s) may be communicated based on the value selected from the range as described with reference to FIG. 3.

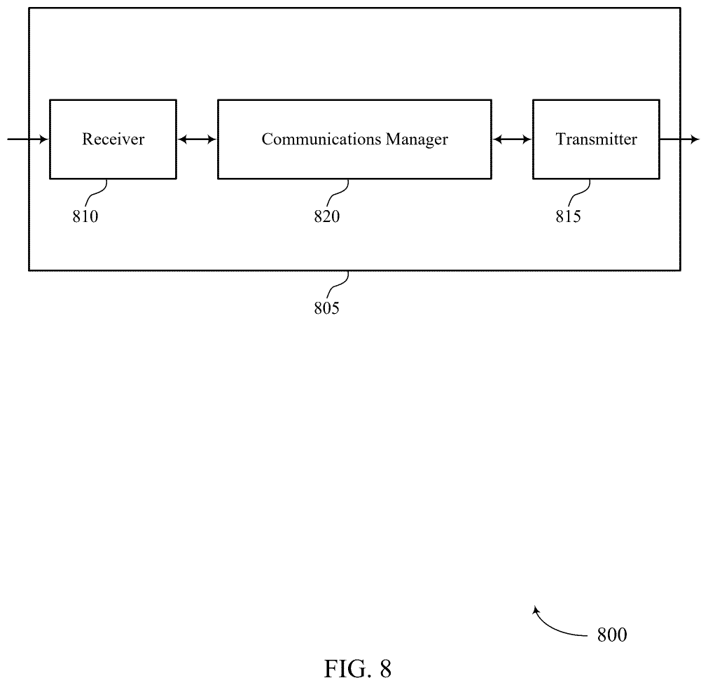

FIG. 8 shows a block diagram 800 of a device 805 that supports configurations for PDU sets in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to configurations for PDU sets). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to configurations for PDU sets). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of configurations for PDU sets as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

For example, the communications manager 820 is capable of, configured to, or operable to support a means for receiving, from a network entity, configuration information for configuring the UE to communicate an indication of one or more KPIs associated with one or more PDU sets, where each PDU set of the one or more PDU sets includes a set of multiple PDUs associated with an ADU for communication between the UE and a network. The communications manager 820 is capable of, configured to, or operable to support a means for communicating, with the network entity, the indication of the one or more KPIs associated with the one or more PDU sets based on the configuration information, where the one or more KPIs are associated with a quantity of lost PDU sets or discarded PDU sets of the one or more PDU sets.

For example, the communications manager 820 is capable of, configured to, or operable to support a means for receiving, from a network entity, configuration information for configuring a range for at least one parameter associated with one or more PDU sets, where each PDU set of the one or more PDU sets includes a set of multiple PDUs associated with an ADU for communication between the UE and a network. The communications manager 820 is capable of, configured to, or operable to support a means for communicating, with the network entity, the one or more PDU sets based on the configuration information, where the one or more PDU sets are communicated based on a value selected from the range for the at least one parameter associated with the one or more PDU sets.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, or more efficient utilization of communication resources.

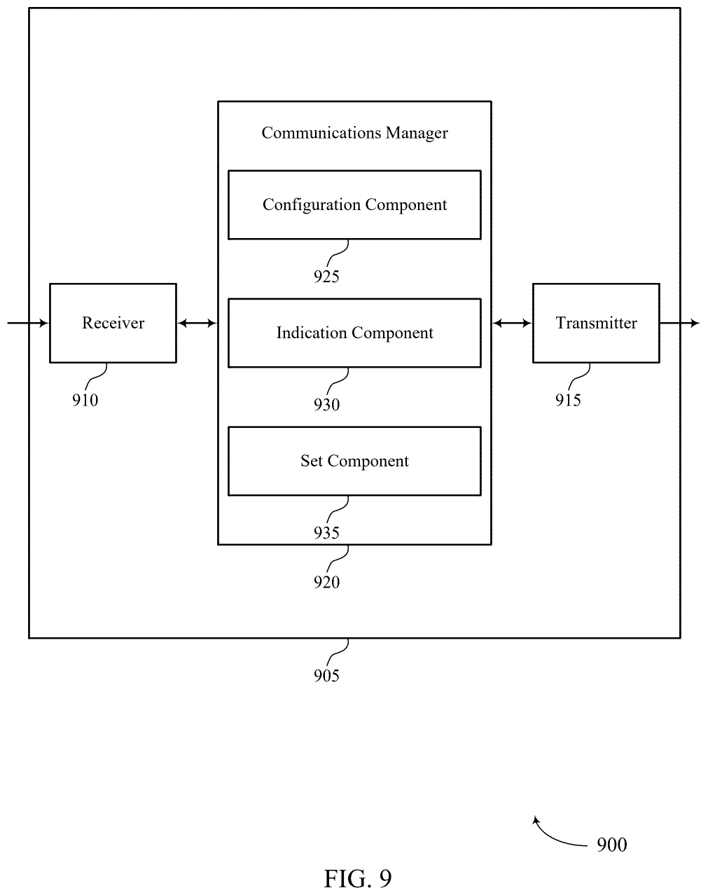

FIG. 9 shows a block diagram 900 of a device 905 that supports configurations for PDU sets in accordance with one or more aspects of the present disclosure. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to configurations for PDU sets). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to configurations for PDU sets). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of configurations for PDU sets as described herein. For example, the communications manager 920 may include a configuration component 925, an indication component 930, a set component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The configuration component 925 is capable of, configured to, or operable to support a means for receiving, from a network entity, configuration information for configuring the UE to communicate an indication of one or more KPIs associated with one or more PDU sets, where each PDU set of the one or more PDU sets includes a set of multiple PDUs associated with an ADU for communication between the UE and a network. The indication component 930 is capable of, configured to, or operable to support a means for communicating, with the network entity, the indication of the one or more KPIs associated with the one or more PDU sets based on the configuration information, where the one or more KPIs are associated with a quantity of lost PDU sets or discarded PDU sets of the one or more PDU sets.

The configuration component 925 is capable of, configured to, or operable to support a means for receiving, from a network entity, configuration information for configuring a range for at least one parameter associated with one or more PDU sets, where each PDU set of the one or more PDU sets includes a set of multiple PDUs associated with an ADU for communication between the UE and a network. The set component 935 is capable of, configured to, or operable to support a means for communicating, with the network entity, the one or more PDU sets based on the configuration information, where the one or more PDU sets are communicated based on a value selected from the range for the at least one parameter associated with the one or more PDU sets.

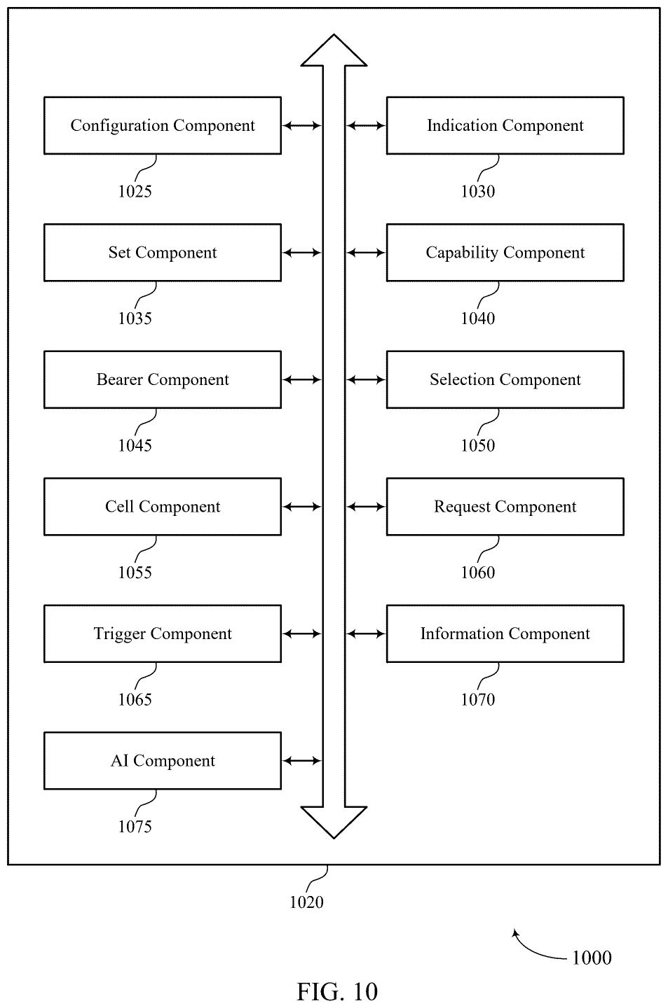

FIG. 10 shows a block diagram 1000 of a communications manager 1020 that supports configurations for PDU sets in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of configurations for PDU sets as described herein. For example, the communications manager 1020 may include a configuration component 1025, an indication component 1030, a set component 1035, a capability component 1040, a bearer component 1045, a selection component 1050, a cell component 1055, a request component 1060, a trigger component 1065, an information component 1070, an AI component 1075, or any combination thereof. Each of these components, or components or subcomponents thereof (e.g., one or more processors, one or more memories), may communicate, directly or indirectly, with one another (e.g., via one or more buses).

The configuration component 1025 is capable of, configured to, or operable to support a means for receiving, from a network entity, configuration information for configuring the UE to communicate an indication of one or more KPIs associated with one or more PDU sets, where each PDU set of the one or more PDU sets includes a set of multiple PDUs associated with an ADU for communication between the UE and a network. The indication component 1030 is capable of, configured to, or operable to support a means for communicating, with the network entity, the indication of the one or more KPIs associated with the one or more PDU sets based on the configuration information, where the one or more KPIs are associated with a quantity of lost PDU sets or discarded PDU sets of the one or more PDU sets.

In some examples, the capability component 1040 is capable of, configured to, or operable to support a means for transmitting, to the network entity, capability information indicating a capability of the UE to communicate the indication of the one or more KPIs associated with the one or more PDU sets.

In some examples, the indication of the one or more KPIs indicates a first quantity of lost PDU sets associated with a PSIHI criterion, a second quantity of lost PDU sets associated with a discard timer expiration, a third quantity of lost PDU sets associated with a reordering timer expiration, or a combination thereof.

In some examples, the indication of the one or more KPIs indicates a first quantity of discarded PDU sets associated with a PSIHI criterion, a second quantity of discarded PDU sets associated with a resource limitation, or a combination thereof.

In some examples, the configuration information indicates an event or a periodic schedule for communicating the indication of the one or more KPIs. In some examples, the indication of the one or more KPIs is communicated based on the event or the periodic schedule.

In some examples, the configuration information indicates a configuration of MAC-CE signaling, packet data convergence protocol (PDCP) signaling, or RRC signaling for the indication of the one or more KPIs. In some examples, the indication of the one or more KPIs is communicated via the MAC-CE signaling, the PDCP signaling, or the RRC signaling. In some examples, communicating the indication of the one or more KPIs is initiated by the UE or the network entity.

In some examples, the bearer component 1045 is capable of, configured to, or operable to support a means for switching from a first radio bearer (RB) to a second RB based on a trigger, where the configuration information indicates the trigger to switch radio bearers in a PDU session based on a PSDB, a PSER, or a PSI metric.

In some examples, the selection component 1050 is capable of, configured to, or operable to support a means for selecting a slice or a PDU session based on a trigger, where the configuration information indicates the trigger to select the slice or the PDU session based on the indication of the one or more KPIs.

In some examples, the cell component 1055 is capable of, configured to, or operable to support a means for switching from a first cell to a second cell based on a cell reselection criterion or a handover criterion, where the configuration information indicates the cell reselection criterion or the handover criterion to switch cells based on the indication of the one or more KPIs.

In some examples, the request component 1060 is capable of, configured to, or operable to support a means for transmitting a request for the indication of the one or more KPIs via MAC-CE signaling, PDCP signaling, or RRC signaling.

In some examples, the trigger component 1065 is capable of, configured to, or operable to support a means for transmitting an indication of a trigger to switch radio bearers in a PDU session based on a PSDB, a PSER, or a PSI metric.

In some examples, the information component 1070 is capable of, configured to, or operable to support a means for transmitting information for modifying a trigger to select a slice or a PDU session based on the indication of the one or more KPIs.

In some examples, the information component 1070 is capable of, configured to, or operable to support a means for transmitting information for modifying a cell reselection criterion or a handover criterion to switch cells based on the indication of the one or more KPIs.

In some examples, the information component 1070 is capable of, configured to, or operable to support a means for transmitting information for modifying a SR procedure, a RACH procedure, or a RLF procedure based on the indication of the one or more KPIs.

In some examples, the configuration component 1025 is capable of, configured to, or operable to support a means for transmitting an indication of a DRX configuration, a bandwidth configuration, or a MIMO configuration via RRC UE assistance information (UAI) signaling based on the indication of the one or more KPIs.

In some examples, an AI model is trained based on the one or more KPIs associated with the one or more PDU sets.

In some examples, the AI component 1075 is capable of, configured to, or operable to support a means for executing an AI model based on the one or more KPIs, where the AI model is executed to set a timer associated with a PDU set, to select a PSI level, or to select a congestion procedure.

In some examples, the configuration component 1025 is capable of, configured to, or operable to support a means for receiving, from a network entity, configuration information for configuring a range for at least one parameter associated with one or more PDU sets, where each PDU set of the one or more PDU sets includes a set of multiple PDUs associated with an ADU for communication between the UE and a network. The set component 1035 is capable of, configured to, or operable to support a means for communicating, with the network entity, the one or more PDU sets based on the configuration information, where the one or more PDU sets are communicated based on a value selected from the range for the at least one parameter associated with the one or more PDU sets.

In some examples, the at least one parameter associated with the one or more PDU sets includes a PSI level, a PSIHI criterion, a trigger associated with a PSDB, a priority associated with a PSDB, a RACH factor associated with a PSDB, a threshold associated with a PSDB, or a combination thereof.

In some examples, the AI component 1075 is capable of, configured to, or operable to support a means for executing an AI model to select the value from the range for the at least one parameter, where a quantity of the one or more PDU sets is discarded from the communication with the network entity based on the value that is selected from the range for the at least one parameter.

In some examples, the quantity of the one or more PDU sets is discarded based on the at least one parameter that includes a PSI level, and based on a resource schedule associated with the one or more PDU sets, protocol information associated with the one or more PDU sets, multi-modal information associated with the one or more PDU sets, frame information associated with the one or more PDU sets, or a combination thereof.

In some examples, the quantity of the one or more PDU sets is discarded based on the at least one parameter that includes a PSIHI criterion, and based on application information associated with the one or more PDU sets, frame information associated with the one or more PDU sets, or a combination thereof.

In some examples, the AI component 1075 is capable of, configured to, or operable to support a means for executing an AI model to select the value from the range for the at least one parameter that includes a PSIHI criterion, where the one or more PDU sets are reassembled from the communication with the network entity based on the value that is selected from the range, payload information associated with the one or more PDU sets, a type of traffic associated with the one or more PDU sets, or a combination thereof.

In some examples, the AI component 1075 is capable of, configured to, or operable to support a means for executing an AI model to select the value from the range for the at least one parameter that is associated with a PSDB or a PSI level, where the one or more PDU sets are prioritized based on the value that is selected from the range.

In some examples, the one or more PDU sets are prioritized to override a configuration parameter associated with a BSR or a DSR, are prioritized for one or more packets during a retransmission, or are prioritized to override a configuration parameter associated with a SR or a RACH procedure.

In some examples, the AI component 1075 is capable of, configured to, or operable to support a means for executing an AI model to select the value from the range for the at least one parameter that is associated with a PSDB or a PSI level for modifying an RLC level trigger, for modifying a retransmission procedure at a layer that is lower than the RLC level, for modifying a resource for communicating the one or more PDU sets, or for reserving power.

In some examples, the set component 1035 is capable of, configured to, or operable to support a means for monitoring one or more KPIs associated with at least one PDU set. In some examples, the AI component 1075 is capable of, configured to, or operable to support a means for training an AI model based on the one or more KPIs, where the AI model is trained to select the value from the range for the at least one parameter.

In some examples, the one or more KPIs indicate a first quantity of PDU sets that are discarded due to a scheduling issue, a second quantity of PDU sets that are discarded due to network congestion, a third quantity of PDU sets that are discarded due to timer expiration, a fourth quantity of PDU sets that are discarded due to a power limitation, or a combination thereof. In some examples, the AI model is trained to select the value from the range based on the first quantity, the second quantity, the third quantity, the fourth quantity, or a combination thereof.

In some examples, the one or more KPIs indicate a first quantity of PDU sets that are discarded due to a reordering timer expiration, a second quantity of PDU sets that are missing due to a PSI level, a scheduling pattern of PDU sets, or a combination thereof. In some examples, the AI model is trained to select the value from the range based on the first quantity, the second quantity, the scheduling pattern, or a combination thereof.

In some examples, the value selected from the range modifies a power limitation procedure, CSI reporting, ARD, or a combination thereof.

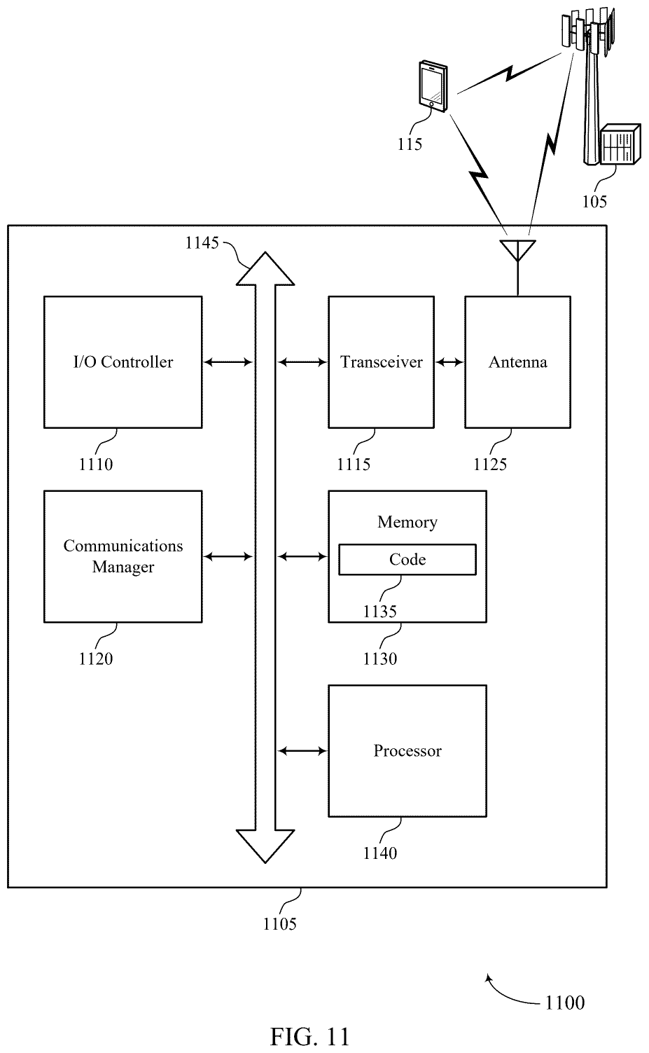

FIG. 11 shows a diagram of a system 1100 including a device 1105 that supports configurations for PDU sets in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting configurations for PDU sets). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

For example, the communications manager 1120 is capable of, configured to, or operable to support a means for receiving, from a network entity, configuration information for configuring the UE to communicate an indication of one or more KPIs associated with one or more PDU sets, where each PDU set of the one or more PDU sets includes a set of multiple PDUs associated with an ADU for communication between the UE and a network. The communications manager 1120 is capable of, configured to, or operable to support a means for communicating, with the network entity, the indication of the one or more KPIs associated with the one or more PDU sets based on the configuration information, where the one or more KPIs are associated with a quantity of lost PDU sets or discarded PDU sets of the one or more PDU sets.

For example, the communications manager 1120 is capable of, configured to, or operable to support a means for receiving, from a network entity, configuration information for configuring a range for at least one parameter associated with one or more PDU sets, where each PDU set of the one or more PDU sets includes a set of multiple PDUs associated with an ADU for communication between the UE and a network. The communications manager 1120 is capable of, configured to, or operable to support a means for communicating, with the network entity, the one or more PDU sets based on the configuration information, where the one or more PDU sets are communicated based on a value selected from the range for the at least one parameter associated with the one or more PDU sets.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of configurations for PDU sets as described herein, or the at least one processor 1140 and the at least one memory 1130 may be otherwise configured to, individually or collectively, perform or support such operations.

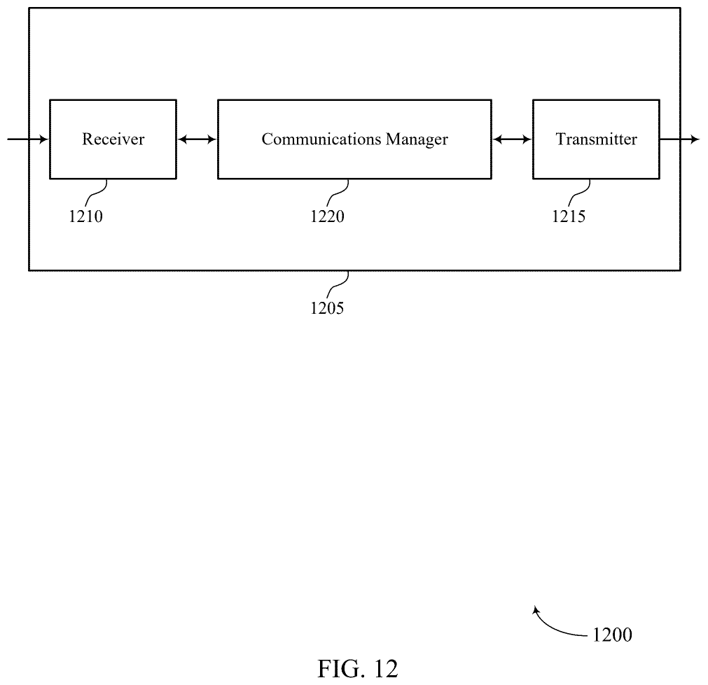

FIG. 12 shows a block diagram 1200 of a device 1205 that supports configurations for PDU sets in accordance with one or more aspects of the present disclosure. The device 1205 may be an example of aspects of a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations or components thereof may be examples of means for performing various aspects of configurations for PDU sets as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

For example, the communications manager 1220 is capable of, configured to, or operable to support a means for sending, to a UE, configuration information for configuring the UE to communicate an indication of one or more KPIs associated with one or more PDU sets, where each PDU set of the one or more PDU sets includes a set of multiple PDUs associated with an ADU for communication between the UE and a network. The communications manager 1220 is capable of, configured to, or operable to support a means for communicating, with the UE, the indication of the one or more KPIs associated with the one or more PDU sets based on the configuration information, where the one or more KPIs are associated with a quantity of lost PDU sets or discarded PDU sets of the one or more PDU sets.

For example, the communications manager 1220 is capable of, configured to, or operable to support a means for sending, to a UE, configuration information for configuring a range for at least one parameter associated with one or more PDU sets, where each PDU set of the one or more PDU sets includes a set of multiple PDUs associated with an ADU for communication between the UE and a network. The communications manager 1220 is capable of, configured to, or operable to support a means for communicating, with the UE, the one or more PDU sets based on the configuration information, where the one or more PDU sets are communicated based on a value selected from the range for the at least one parameter associated with the one or more PDU sets.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, or more efficient utilization of communication resources.

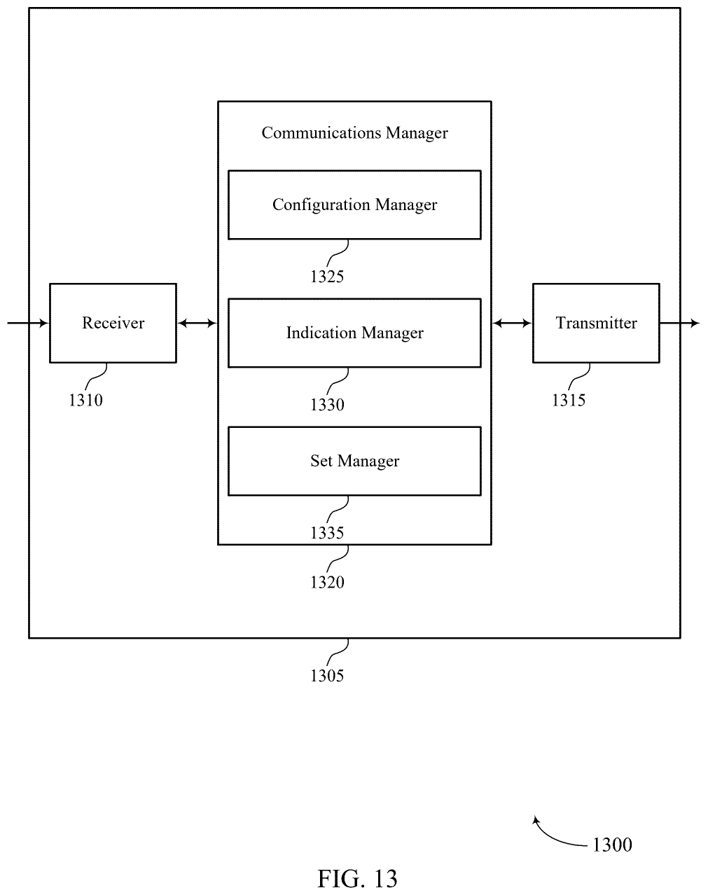

FIG. 13 shows a block diagram 1300 of a device 1305 that supports configurations for PDU sets in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of configurations for PDU sets as described herein. For example, the communications manager 1320 may include a configuration manager 1325, an indication manager 1330, a set manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The configuration manager 1325 is capable of, configured to, or operable to support a means for sending, to a UE, configuration information for configuring the UE to communicate an indication of one or more KPIs associated with one or more PDU sets, where each PDU set of the one or more PDU sets includes a set of multiple PDUs associated with an ADU for communication between the UE and a network. The indication manager 1330 is capable of, configured to, or operable to support a means for communicating, with the UE, the indication of the one or more KPIs associated with the one or more PDU sets based on the configuration information, where the one or more KPIs are associated with a quantity of lost PDU sets or discarded PDU sets of the one or more PDU sets.

The configuration manager 1325 is capable of, configured to, or operable to support a means for sending, to a UE, configuration information for configuring a range for at least one parameter associated with one or more PDU sets, where each PDU set of the one or more PDU sets includes a set of multiple PDUs associated with an ADU for communication between the UE and a network. The set manager 1335 is capable of, configured to, or operable to support a means for communicating, with the UE, the one or more PDU sets based on the configuration information, where the one or more PDU sets are communicated based on a value selected from the range for the at least one parameter associated with the one or more PDU sets.

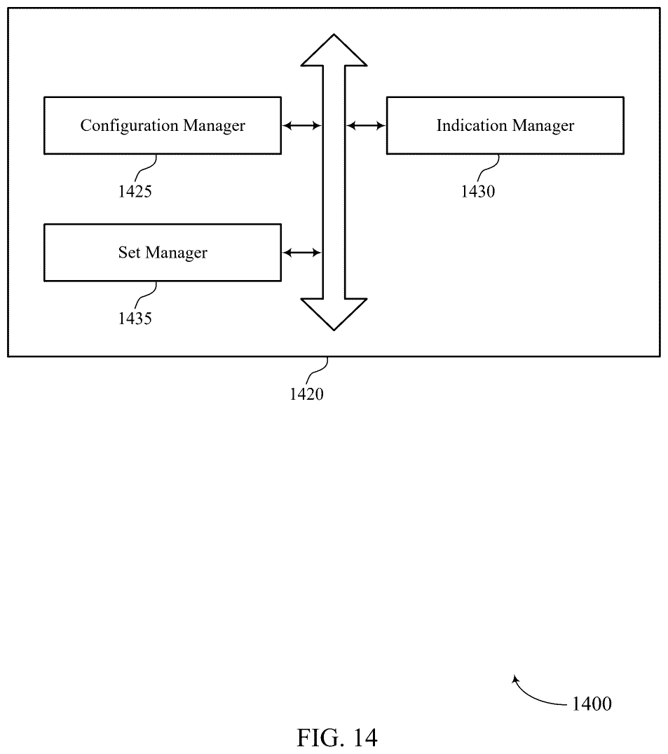

FIG. 14 shows a block diagram 1400 of a communications manager 1420 that supports configurations for PDU sets in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of configurations for PDU sets as described herein. For example, the communications manager 1420 may include a configuration manager 1425, an indication manager 1430, a set manager 1435, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The configuration manager 1425 is capable of, configured to, or operable to support a means for sending, to a UE, configuration information for configuring the UE to communicate an indication of one or more KPIs associated with one or more PDU sets, where each PDU set of the one or more PDU sets includes a set of multiple PDUs associated with an ADU for communication between the UE and a network. The indication manager 1430 is capable of, configured to, or operable to support a means for communicating, with the UE, the indication of the one or more KPIs associated with the one or more PDU sets based on the configuration information, where the one or more KPIs are associated with a quantity of lost PDU sets or discarded PDU sets of the one or more PDU sets.

In some examples, the configuration manager 1425 is capable of, configured to, or operable to support a means for sending, to a UE, configuration information for configuring a range for at least one parameter associated with one or more PDU sets, where each PDU set of the one or more PDU sets includes a set of multiple PDUs associated with an ADU for communication between the UE and a network. The set manager 1435 is capable of, configured to, or operable to support a means for communicating, with the UE, the one or more PDU sets based on the configuration information, where the one or more PDU sets are communicated based on a value selected from the range for the at least one parameter associated with the one or more PDU sets.

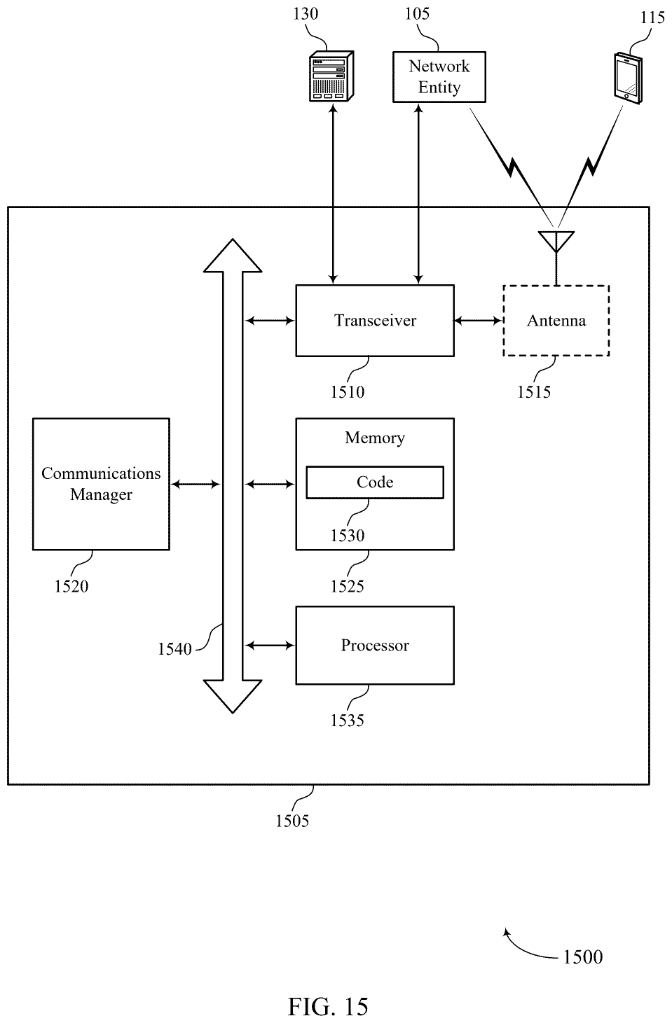

FIG. 15 shows a diagram of a system 1500 including a device 1505 that supports configurations for PDU sets in accordance with one or more aspects of the present disclosure. The device 1505 may be an example of or include components of a device 1205, a device 1305, or a network entity 105 as described herein. The device 1505 may communicate with other network devices or network equipment such as one or more of the network entities 105, UEs 115, or any combination thereof. The communications may include communications over one or more wired interfaces, over one or more wireless interfaces, or any combination thereof. The device 1505 may include components that support outputting and obtaining communications, such as a communications manager 1520, a transceiver 1510, one or more antennas 1515, at least one memory 1525, code 1530, and at least one processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or one or more memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or one or more memory components (e.g., the at least one processor 1535, the at least one memory 1525, or both), may be included in a chip or chip assembly that is installed in the device 1505. In some examples, the transceiver 1510 may be operable to support communications via one or more communications links (e.g., communication link(s) 125, backhaul communication link(s) 120, a midhaul communication link 162, a fronthaul communication link 168).

The at least one memory 1525 may include RAM, ROM, or any combination thereof. The at least one memory 1525 may store computer-readable, computer-executable, or processor-executable code, such as the code 1530. The code 1530 may include instructions that, when executed by one or more of the at least one processor 1535, cause the device 1505 to perform various functions described herein. The code 1530 may be stored in a non-transitory computer-readable medium such as system memory or another type of memory. In some cases, the code 1530 may not be directly executable by a processor of the at least one processor 1535 but may cause a computer (e.g., when compiled and executed) to perform functions described herein. In some cases, the at least one memory 1525 may include, among other things, a BIOS which may control basic hardware or software operation such as the interaction with peripheral components or devices. In some examples, the at least one processor 1535 may include multiple processors and the at least one memory 1525 may include multiple memories. One or more of the multiple processors may be coupled with one or more of the multiple memories which may, individually or collectively, be configured to perform various functions herein (for example, as part of a processing system).

The at least one processor 1535 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1535 may be configured to operate a memory array using a memory controller. In some other cases, a memory controller may be integrated into one or more of the at least one processor 1535. The at least one processor 1535 may be configured to execute computer-readable instructions stored in a memory (e.g., one or more of the at least one memory 1525) to cause the device 1505 to perform various functions (e.g., functions or tasks supporting configurations for PDU sets). For example, the device 1505 or a component of the device 1505 may include at least one processor 1535 and at least one memory 1525 coupled with one or more of the at least one processor 1535, the at least one processor 1535 and the at least one memory 1525 configured to perform various functions described herein. The at least one processor 1535 may be an example of a cloud-computing platform (e.g., one or more physical nodes and supporting software such as operating systems, virtual machines, or container instances) that may host the functions (e.g., by executing code 1530) to perform the functions of the device 1505. The at least one processor 1535 may be any one or more suitable processors capable of executing scripts or instructions of one or more software programs stored in the device 1505 (such as within one or more of the at least one memory 1525).

In some examples, the at least one processor 1535 may include multiple processors and the at least one memory 1525 may include multiple memories. One or more of the multiple processors may be coupled with one or more of the multiple memories, which may, individually or collectively, be configured to perform various functions herein. In some examples, the at least one processor 1535 may be a component of a processing system, which may refer to a system (such as a series) of machines, circuitry (including, for example, one or both of processor circuitry (which may include the at least one processor 1535) and memory circuitry (which may include the at least one memory 1525)), or components, that receives or obtains inputs and processes the inputs to produce, generate, or obtain a set of outputs. The processing system may be configured to perform one or more of the functions described herein. For example, the at least one processor 1535 or a processing system including the at least one processor 1535 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1525 or otherwise, to perform one or more of the functions described herein.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the at least one memory 1525, the code 1530, and the at least one processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with one or more other network entities 105, and may include a controller or scheduler for controlling communications with UEs 115 (e.g., in cooperation with the one or more other network devices). In some examples, the communications manager 1520 may support an X2 interface within an LTE/LTE-A wireless communications network technology to provide communication between network entities 105.

For example, the communications manager 1520 is capable of, configured to, or operable to support a means for sending, to a UE, configuration information for configuring the UE to communicate an indication of one or more KPIs associated with one or more PDU sets, where each PDU set of the one or more PDU sets includes a set of multiple PDUs associated with an ADU for communication between the UE and a network. The communications manager 1520 is capable of, configured to, or operable to support a means for communicating, with the UE, the indication of the one or more KPIs associated with the one or more PDU sets based on the configuration information, where the one or more KPIs are associated with a quantity of lost PDU sets or discarded PDU sets of the one or more PDU sets.

For example, the communications manager 1520 is capable of, configured to, or operable to support a means for sending, to a UE, configuration information for configuring a range for at least one parameter associated with one or more PDU sets, where each PDU set of the one or more PDU sets includes a set of multiple PDUs associated with an ADU for communication between the UE and a network. The communications manager 1520 is capable of, configured to, or operable to support a means for communicating, with the UE, the one or more PDU sets based on the configuration information, where the one or more PDU sets are communicated based on a value selected from the range for the at least one parameter associated with the one or more PDU sets.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, one or more of the at least one processor 1535, one or more of the at least one memory 1525, the code 1530, or any combination thereof (for example, by a processing system including at least a portion of the at least one processor 1535, the at least one memory 1525, the code 1530, or any combination thereof). For example, the code 1530 may include instructions executable by one or more of the at least one processor 1535 to cause the device 1505 to perform various aspects of configurations for PDU sets as described herein, or the at least one processor 1535 and the at least one memory 1525 may be otherwise configured to, individually or collectively, perform or support such operations.

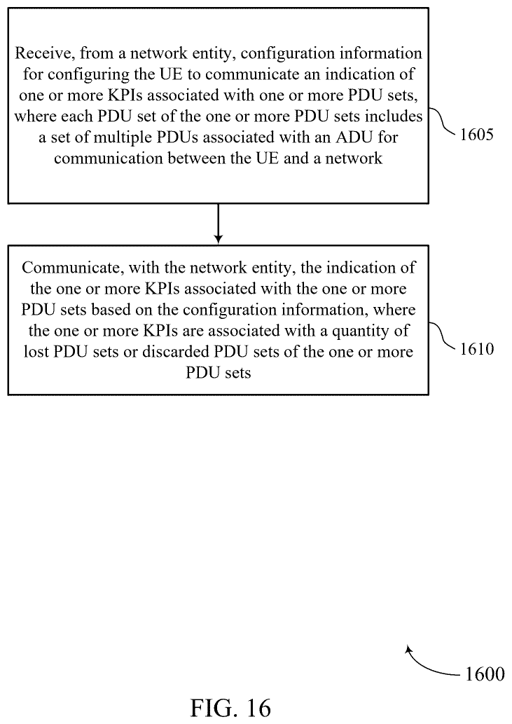

FIG. 16 shows a flowchart illustrating a method 1600 that supports configurations for PDU sets in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, configuration information for configuring the UE to communicate an indication of one or more KPIs associated with one or more PDU sets, where each PDU set of the one or more PDU sets includes a set of multiple PDUs associated with an ADU for communication between the UE and a network. The operations of 1605 may be performed in accordance with examples as disclosed herein. In some examples, aspects of the operations of 1605 may be performed by a configuration component 1025 as described with reference to FIG. 10.

At 1610, the method may include communicating, with the network entity, the indication of the one or more KPIs associated with the one or more PDU sets based on the configuration information, where the one or more KPIs are associated with a quantity of lost PDU sets or discarded PDU sets of the one or more PDU sets. The operations of 1610 may be performed in accordance with examples as disclosed herein. In some examples, aspects of the operations of 1610 may be performed by an indication component 1030 as described with reference to FIG. 10.

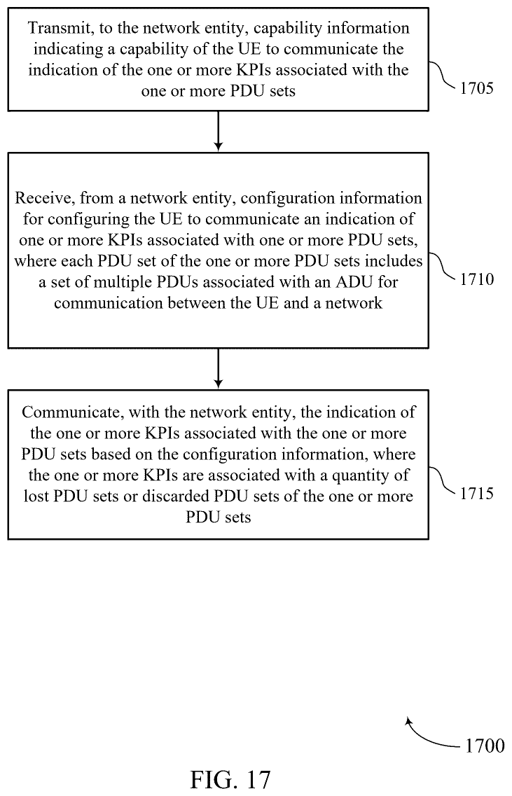

FIG. 17 shows a flowchart illustrating a method 1700 that supports configurations for PDU sets in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include transmitting, to the network entity, capability information indicating a capability of the UE to communicate an indication of the one or more KPIs associated with the one or more PDU sets. The operations of 1705 may be performed in accordance with examples as disclosed herein. In some examples, aspects of the operations of 1705 may be performed by a capability component 1040 as described with reference to FIG. 10.

At 1710, the method may include receiving, from a network entity, configuration information for configuring the UE to communicate the indication of one or more KPIs associated with one or more PDU sets, where each PDU set of the one or more PDU sets includes a set of multiple PDUs associated with an ADU for communication between the UE and a network. The operations of 1710 may be performed in accordance with examples as disclosed herein. In some examples, aspects of the operations of 1710 may be performed by a configuration component 1025 as described with reference to FIG. 10.

At 1715, the method may include communicating, with the network entity, the indication of the one or more KPIs associated with the one or more PDU sets based on the configuration information, where the one or more KPIs are associated with a quantity of lost PDU sets or discarded PDU sets of the one or more PDU sets. The operations of 1715 may be performed in accordance with examples as disclosed herein. In some examples, aspects of the operations of 1715 may be performed by an indication component 1030 as described with reference to FIG. 10.

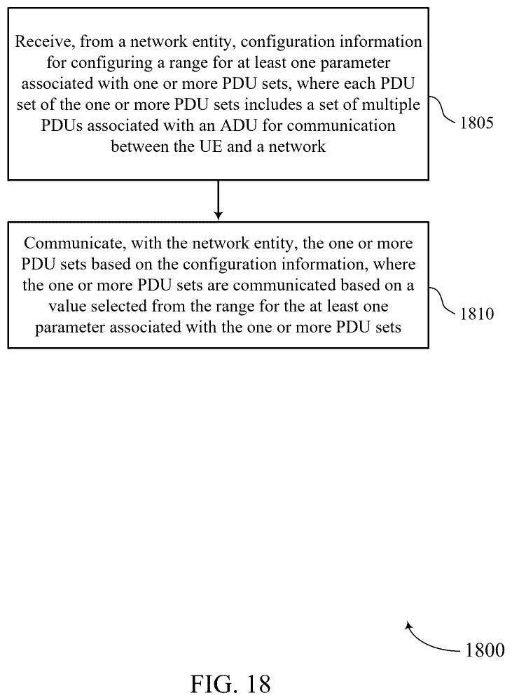

FIG. 18 shows a flowchart illustrating a method 1800 that supports configurations for PDU sets in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include receiving, from a network entity, configuration information for configuring a range for at least one parameter associated with one or more PDU sets, where each PDU set of the one or more PDU sets includes a set of multiple PDUs associated with an ADU for communication between the UE and a network. The operations of 1805 may be performed in accordance with examples as disclosed herein. In some examples, aspects of the operations of 1805 may be performed by a configuration component 1025 as described with reference to FIG. 10.

At 1810, the method may include communicating, with the network entity, the one or more PDU sets based on the configuration information, where the one or more PDU sets are communicated based on a value selected from the range for the at least one parameter associated with the one or more PDU sets. The operations of 1810 may be performed in accordance with examples as disclosed herein. In some examples, aspects of the operations of 1810 may be performed by a set component 1035 as described with reference to FIG. 10.

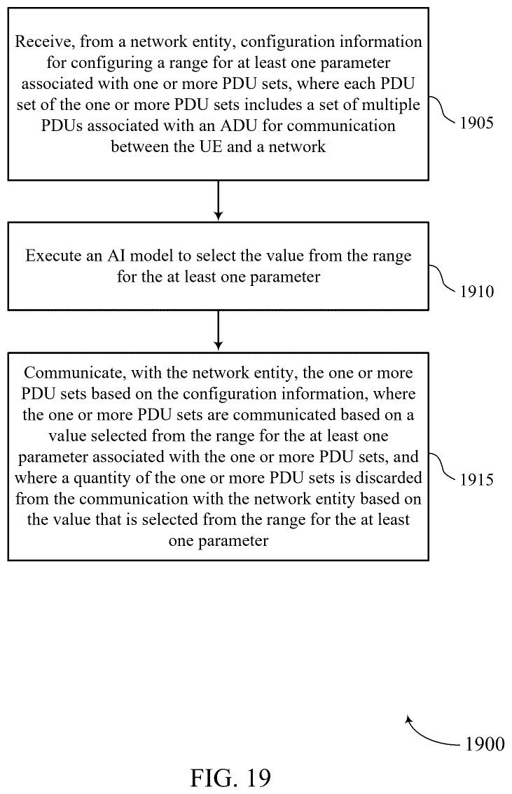

FIG. 19 shows a flowchart illustrating a method 1900 that supports configurations for PDU sets in accordance with one or more aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1905, the method may include receiving, from a network entity, configuration information for configuring a range for at least one parameter associated with one or more PDU sets, where each PDU set of the one or more PDU sets includes a set of multiple PDUs associated with an ADU for communication between the UE and a network. The operations of 1905 may be performed in accordance with examples as disclosed herein. In some examples, aspects of the operations of 1905 may be performed by a configuration component 1025 as described with reference to FIG. 10.

At 1910, the method may include executing an AI model to select the value from the range for the at least one parameter. The operations of 1910 may be performed in accordance with examples as disclosed herein. In some examples, aspects of the operations of 1910 may be performed by an AI component 1075 as described with reference to FIG. 10.

At 1915, the method may include communicating, with the network entity, the one or more PDU sets based on the configuration information, where the one or more PDU sets are communicated based on a value selected from the range for the at least one parameter associated with the one or more PDU sets, and where a quantity of the one or more PDU sets is discarded from the communication with the network entity based on the value that is selected from the range for the at least one parameter. The operations of 1915 may be performed in accordance with examples as disclosed herein. In some examples, aspects of the operations of 1915 may be performed by a set component 1035 as described with reference to FIG. 10.

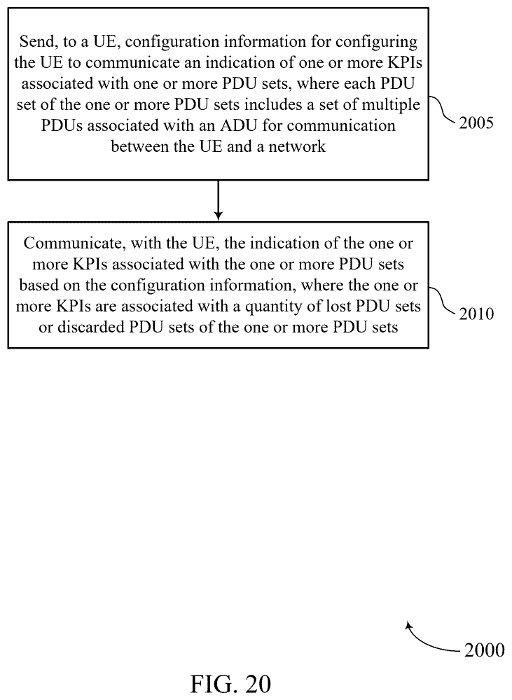

FIG. 20 shows a flowchart illustrating a method 2000 that supports configurations for PDU sets in accordance with one or more aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2005, the method may include sending, to a UE, configuration information for configuring the UE to communicate an indication of one or more KPIs associated with one or more PDU sets, where each PDU set of the one or more PDU sets includes a set of multiple PDUs associated with an ADU for communication between the UE and a network. The operations of 2005 may be performed in accordance with examples as disclosed herein. In some examples, aspects of the operations of 2005 may be performed by a configuration manager 1425 as described with reference to FIG. 14.

At 2010, the method may include communicating, with the UE, the indication of the one or more KPIs associated with the one or more PDU sets based on the configuration information, where the one or more KPIs are associated with a quantity of lost PDU sets or discarded PDU sets of the one or more PDU sets. The operations of 2010 may be performed in accordance with examples as disclosed herein. In some examples, aspects of the operations of 2010 may be performed by an indication manager 1430 as described with reference to FIG. 14.

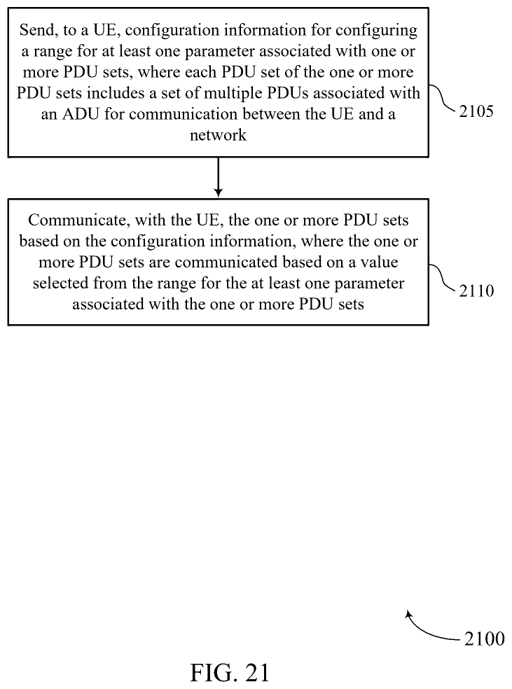

FIG. 21 shows a flowchart illustrating a method 2100 that supports configurations for PDU sets in accordance with one or more aspects of the present disclosure. The operations of the method 2100 may be implemented by a network entity or its components as described herein. For example, the operations of the method 2100 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 2105, the method may include sending, to a UE, configuration information for configuring a range for at least one parameter associated with one or more PDU sets, where each PDU set of the one or more PDU sets includes a set of multiple PDUs associated with an ADU for communication between the UE and a network. The operations of 2105 may be performed in accordance with examples as disclosed herein. In some examples, aspects of the operations of 2105 may be performed by a configuration manager 1425 as described with reference to FIG. 14.

At 2110, the method may include communicating, with the UE, the one or more PDU sets based on the configuration information, where the one or more PDU sets are communicated based on a value selected from the range for the at least one parameter associated with the one or more PDU sets. The operations of 2110 may be performed in accordance with examples as disclosed herein. In some examples, aspects of the operations of 2110 may be performed by a set manager 1435 as described with reference to FIG. 14.

The following provides an overview of aspects of the present disclosure:
Aspect 1: A method for wireless communications by a UE, comprising: receiving, from a network entity, configuration information for configuring the UE to communicate an indication of one or more KPIs associated with one or more PDU sets, wherein each PDU set of the one or more PDU sets comprises a plurality of PDUs associated with an ADU for communication between the UE and a network; and communicating, with the network entity, the indication of the one or more KPIs associated with the one or more PDU sets based at least in part on the configuration information, wherein the one or more KPIs are associated with a quantity of lost PDU sets or discarded PDU sets of the one or more PDU sets.
Aspect 2: The method of aspect 1, further comprising: transmitting, to the network entity, capability information indicating a capability of the UE to communicate the indication of the one or more KPIs associated with the one or more PDU sets.
Aspect 3: The method of any of aspects 1 through 2, wherein the indication of the one or more KPIs indicates a first quantity of lost PDU sets associated with a PSIHI criterion, a second quantity of lost PDU sets associated with a discard timer expiration, a third quantity of lost PDU sets associated with a reordering timer expiration, or a combination thereof.
Aspect 4: The method of any of aspects 1 through 3, wherein the indication of the one or more KPIs indicates a first quantity of discarded PDU sets associated with a PSIHI criterion, a second quantity of discarded PDU sets associated with a resource limitation, or a combination thereof.
Aspect 5: The method of any of aspects 1 through 4, wherein the configuration information indicates an event or a periodic schedule for communicating the indication of the one or more KPIs, and the indication of the one or more KPIs is communicated based at least in part on the event or the periodic schedule.
Aspect 6: The method of any of aspects 1 through 5, wherein the configuration information indicates a configuration of MAC-CE signaling, PDCP signaling, or RRC signaling for the indication of the one or more KPIs, the indication of the one or more KPIs is communicated via the MAC-CE signaling, the PDCP signaling, or the RRC signaling, and communicating the indication of the one or more KPIs is initiated by the UE or the network entity.
Aspect 7: The method of any of aspects 1 through 6, further comprising: switching from a first RB to a second RB based on a trigger, wherein the configuration information indicates the trigger to switch radio bearers in a PDU session based at least in part on a PSDB, a PSER, or a PSI metric.
Aspect 8: The method of any of aspects 1 through 7, further comprising: selecting a slice or a PDU session based at least in part on a trigger, wherein the configuration information indicates the trigger to select the slice or the PDU session based at least in part on the indication of the one or more KPIs.
Aspect 9: The method of any of aspects 1 through 8, further comprising: switching from a first cell to a second cell based at least in part on a cell reselection criterion or a handover criterion, wherein the configuration information indicates the cell reselection criterion or the handover criterion to switch cells based at least in part on the indication of the one or more KPIs.
Aspect 10: The method of any of aspects 1 through 9, further comprising: transmitting a request for the indication of the one or more KPIs via MAC-CE signaling, PDCP signaling, or RRC signaling.
Aspect 11: The method of any of aspects 1 through 10, further comprising: transmitting an indication of a trigger to switch radio bearers in a PDU session based at least in part on a PSDB, a PSER, or a PSI metric.
Aspect 12: The method of any of aspects 1 through 11, further comprising: transmitting information for modifying a trigger to select a slice or a PDU session based at least in part on the indication of the one or more KPIs.
Aspect 13: The method of any of aspects 1 through 12, further comprising: transmitting information for modifying a cell reselection criterion or a handover criterion to switch cells based at least in part on the indication of the one or more KPIs.
Aspect 14: The method of any of aspects 1 through 13, further comprising: transmitting information for modifying a SR procedure, a RACH procedure, or a RLF procedure based at least in part on the indication of the one or more KPIs.
Aspect 15: The method of any of aspects 1 through 14, further comprising: transmitting an indication of a DRX configuration, a bandwidth configuration, or a MIMO configuration via RRC UAI signaling based at least in part on the indication of the one or more KPIs.
Aspect 16: The method of any of aspects 1 through 15, wherein an AI model is trained based at least in part on the one or more KPIs associated with the one or more PDU sets.
Aspect 17: The method of any of aspects 1 through 16, further comprising: executing an AI model based at least in part on the one or more KPIs, wherein the AI model is executed to set a timer associated with a PDU set, to select a PSI level, or to select a congestion procedure.
Aspect 18: A method for wireless communications by a UE, comprising: receiving, from a network entity, configuration information for configuring a range for at least one parameter associated with one or more PDU sets, wherein each PDU set of the one or more PDU sets comprises a plurality of PDUs associated with an ADU for communication between the UE and a network; and communicating, with the network entity, the one or more PDU sets based at least in part on the configuration information, wherein the one or more PDU sets are communicated based at least in part on a value selected from the range for the at least one parameter associated with the one or more PDU sets.
Aspect 19: The method of aspect 18, wherein the at least one parameter associated with the one or more PDU sets comprises a PSI level, a PSIHI criterion, a trigger associated with a PSDB, a priority associated with a PSDB, a RACH factor associated with a PSDB, a threshold associated with a PSDB, or a combination thereof.
Aspect 20: The method of any of aspects 18 through 19, further comprising: executing an AI model to select the value from the range for the at least one parameter, wherein a quantity of the one or more PDU sets is discarded from the communication with the network entity based at least in part on the value that is selected from the range for the at least one parameter.
Aspect 21: The method of aspect 20, wherein the quantity of the one or more PDU sets is discarded based at least in part on the at least one parameter that comprises a PSI level, and based at least in part on a resource schedule associated with the one or more PDU sets, protocol information associated with the one or more PDU sets, multi-modal information associated with the one or more PDU sets, frame information associated with the one or more PDU sets, or a combination thereof.
Aspect 22: The method of any of aspects 20 through 21, wherein the quantity of the one or more PDU sets is discarded based at least in part on the at least one parameter that comprises a PSIHI criterion, and based at least in part on application information associated with the one or more PDU sets, frame information associated with the one or more PDU sets, or a combination thereof.
Aspect 23: The method of any of aspects 18 through 19, further comprising: executing an AI model to select the value from the range for the at least one parameter that comprises a PSIHI criterion, wherein the one or more PDU sets are reassembled from the communication with the network entity based at least in part on the value that is selected from the range, payload information associated with the one or more PDU sets, a type of traffic associated with the one or more PDU sets, or a combination thereof.
Aspect 24: The method of any of aspects 18 through 23, further comprising: executing an AI model to select the value from the range for the at least one parameter that is associated with a PSDB or a PSI level, wherein the one or more PDU sets are prioritized based on the value that is selected from the range.
Aspect 25: The method of aspect 24, wherein the one or more PDU sets are prioritized to override a configuration parameter associated with a BSR or a DSR, are prioritized for one or more packets during a retransmission, or are prioritized to override a configuration parameter associated with a SR or a RACH procedure.
Aspect 26: The method of any of aspects 18 through 25, further comprising: executing an AI model to select the value from the range for the at least one parameter that is associated with a PSDB or a PSI level for modifying an RLC level trigger, for modifying a retransmission procedure at a layer that is lower than the RLC level, for modifying a resource for communicating the one or more PDU sets, or for reserving power.
Aspect 27: The method of any of aspects 18 through 19, further comprising: monitoring one or more KPIs associated with at least one PDU set; and training an AI model based at least in part on the one or more KPIs, wherein the AI model is trained to select the value from the range for the at least one parameter.
Aspect 28: The method of aspect 27, wherein the one or more KPIs indicate a first quantity of PDU sets that are discarded due to a scheduling issue, a second quantity of PDU sets that are discarded due to network congestion, a third quantity of PDU sets that are discarded due to timer expiration, a fourth quantity of PDU sets that are discarded due to a power limitation, or a combination thereof, and the AI model is trained to select the value from the range based at least in part on the first quantity, the second quantity, the third quantity, the fourth quantity, or a combination thereof.
Aspect 29: The method of any of aspects 27 through 28, wherein the one or more KPIs indicate a first quantity of PDU sets that are discarded due to a reordering timer expiration, a second quantity of PDU sets that are missing due to a PSI level, a scheduling pattern of PDU sets, or a combination thereof, and the AI model is trained to select the value from the range based at least in part on the first quantity, the second quantity, the scheduling pattern, or a combination thereof.
Aspect 30: The method of any of aspects 18 through 29, wherein the value selected from the range modifies a power limitation procedure, CSI reporting, ARD, or a combination thereof.
Aspect 31: A method for wireless communications by a network entity, comprising: sending, to a UE, configuration information for configuring the UE to communicate an indication of one or more KPIs associated with one or more PDU sets, wherein each PDU set of the one or more PDU sets comprises a plurality of PDUs associated with an ADU for communication between the UE and a network; and communicating, with the UE, the indication of the one or more KPIs associated with the one or more PDU sets based at least in part on the configuration information, wherein the one or more KPIs are associated with a quantity of lost PDU sets or discarded PDU sets of the one or more PDU sets.
Aspect 32: A method for wireless communications by a network entity, comprising: sending, to a UE, configuration information for configuring a range for at least one parameter associated with one or more PDU sets, wherein each PDU set of the one or more PDU sets comprises a plurality of PDUs associated with an ADU for communication between the UE and a network; and communicating, with the UE, the one or more PDU sets based at least in part on the configuration information, wherein the one or more PDU sets are communicated based at least in part on a value selected from the range for the at least one parameter associated with the one or more PDU sets.
Aspect 33: A UE comprising one or more memories storing processor-executable code, and one or more processors coupled with the one or more memories and individually or collectively operable to execute the code to cause the UE to perform a method of any of aspects 1 through 17.
Aspect 34: A UE comprising at least one means for performing a method of any of aspects 1 through 17.
Aspect 35: A non-transitory computer-readable medium storing code the code comprising instructions executable by one or more processors to perform a method of any of aspects 1 through 17.
Aspect 36: A UE comprising one or more memories storing processor-executable code, and one or more processors coupled with the one or more memories and individually or collectively operable to execute the code to cause the UE to perform a method of any of aspects 18 through 30.
Aspect 37: A UE comprising at least one means for performing a method of any of aspects 18 through 30.
Aspect 38: A non-transitory computer-readable medium storing code the code comprising instructions executable by one or more processors to perform a method of any of aspects 18 through 30.
Aspect 39: A network entity comprising one or more memories storing processor-executable code, and one or more processors coupled with the one or more memories and individually or collectively operable to execute the code to cause the network entity to perform a method of aspect 31.
Aspect 40: A network entity comprising at least one means for performing a method of aspect 31.
Aspect 41: A non-transitory computer-readable medium storing code the code comprising instructions executable by one or more processors to perform a method of any of aspect 31.
Aspect 42: A network entity comprising one or more memories storing processor-executable code, and one or more processors coupled with the one or more memories and individually or collectively operable to execute the code to cause the network entity to perform a method of aspect 32.
Aspect 43: A network entity comprising at least one means for performing a method of aspect 32.
Aspect 44: A non-transitory computer-readable medium storing code the code comprising instructions executable by one or more processors to perform a method of aspect 32.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, configuration information for configuring the UE to communicate an indication of one or more key performance indicators (KPIs) associated with one or more protocol data unit (PDU) sets, wherein each PDU set of the one or more PDU sets comprises a plurality of PDUs associated with an application data unit (ADU) for communication between the UE and a network; and
communicate, with the network entity, the indication of the one or more KPIs associated with the one or more PDU sets based at least in part on the configuration information, wherein the one or more KPIs are associated with a quantity of lost PDU sets or discarded PDU sets of the one or more PDU sets.

2. The UE of claim 1, wherein the one or more processors are individually or collectively further operable to execute the code to cause the UE to:
transmit, to the network entity, capability information indicating a capability of the UE to communicate the indication of the one or more KPIs associated with the one or more PDU sets.

3. The UE of claim 1, wherein the indication of the one or more KPIs indicates a first quantity of lost PDU sets associated with a PDU set integrated handling information (PSIHI) criterion, a second quantity of lost PDU sets associated with a discard timer expiration, a third quantity of lost PDU sets associated with a reordering timer expiration, or a combination thereof.

4. The UE of claim 1, wherein the indication of the one or more KPIs indicates a first quantity of discarded PDU sets associated with a PDU set integrated handling information (PSIHI) criterion, a second quantity of discarded PDU sets associated with a resource limitation, or a combination thereof.

5. The UE of claim 1, wherein the one or more processors are individually or collectively further operable to execute the code to cause the UE to:
switch from a first radio bearer (RB) to a second RB based on a trigger, wherein the configuration information indicates the trigger to switch radio bearers in a PDU session based at least in part on a PDU set delay budget (PSDB), a PDU set error rate (PSER), or a PDU set importance (PSI) metric.

6. The UE of claim 1, wherein the one or more processors are individually or collectively further operable to execute the code to cause the UE to:
select a slice or a PDU session based at least in part on a trigger, wherein the configuration information indicates the trigger to select the slice or the PDU session based at least in part on the indication of the one or more KPIs.

7. The UE of claim 1, wherein the one or more processors are individually or collectively further operable to execute the code to cause the UE to:
switch from a first cell to a second cell based at least in part on a cell reselection criterion or a handover criterion, wherein the configuration information indicates the cell reselection criterion or the handover criterion to switch cells based at least in part on the indication of the one or more KPIs.

8. The UE of claim 1, wherein the one or more processors are individually or collectively further operable to execute the code to cause the UE to:
transmit an indication of a trigger to switch radio bearers in a PDU session based at least in part on a PDU set delay budget (PSDB), a PDU set error rate (PSER), or a PDU set importance (PSI) metric.

9. The UE of claim 1, wherein the one or more processors are individually or collectively further operable to execute the code to cause the UE to:
transmit information for modifying a trigger to select a slice or a PDU session based at least in part on the indication of the one or more KPIs.

10. The UE of claim 1, wherein the one or more processors are individually or collectively further operable to execute the code to cause the UE to:
transmit information for modifying a cell reselection criterion or a handover criterion to switch cells based at least in part on the indication of the one or more KPIs.

11. The UE of claim 1, wherein the one or more processors are individually or collectively further operable to execute the code to cause the UE to:
execute an artificial intelligence (AI) model based at least in part on the one or more KPIs, wherein the AI model is executed to set a timer associated with a PDU set, to select a PDU set importance (PSI) level, or to select a congestion procedure.

12. A user equipment (UE), comprising:
one or more memories storing processor-executable code; and
one or more processors coupled with the one or more memories and individually or collectively operable to execute the code to cause the UE to:
receive, from a network entity, configuration information for configuring a range for at least one parameter associated with one or more protocol data unit (PDU) sets, wherein each PDU set of the one or more PDU sets comprises a plurality of PDUs associated with an application data unit (ADU) for communication between the UE and a network; and
communicate, with the network entity, the one or more PDU sets based at least in part on the configuration information, wherein the one or more PDU sets are communicated based at least in part on a value selected from the range for the at least one parameter associated with the one or more PDU sets.

13. The UE of claim 12, wherein the at least one parameter associated with the one or more PDU sets comprises a PDU set importance (PSI) level, a PDU set integrated handling information (PSIHI) criterion, a trigger associated with a PDU set delay budget (PSDB), a priority associated with a PSDB, a random access channel (RACH) factor associated with a PSDB, a threshold associated with a PSDB, or a combination thereof.

14. The UE of claim 12, wherein the one or more processors are individually or collectively further operable to execute the code to cause the UE to:
execute an artificial intelligence (AI) model to select the value from the range for the at least one parameter, wherein a quantity of the one or more PDU sets is discarded from the communication with the network entity based at least in part on the value that is selected from the range for the at least one parameter.

15. The UE of claim 12, wherein the one or more processors are individually or collectively further operable to execute the code to cause the UE to:
execute an artificial intelligence (AI) model to select the value from the range for the at least one parameter that comprises a PDU set integrated handling information (PSIHI) criterion, wherein the one or more PDU sets are reassembled from the communication with the network entity based at least in part on the value that is selected from the range, payload information associated with the one or more PDU sets, a type of traffic associated with the one or more PDU sets, or a combination thereof.

16. The UE of claim 12, wherein the one or more processors are individually or collectively further operable to execute the code to cause the UE to:
execute an artificial intelligence (AI) model to select the value from the range for the at least one parameter that is associated with a PDU set delay budget (PSDB) or a PDU set importance (PSI) level, wherein the one or more PDU sets are prioritized based on the value that is selected from the range.

17. The UE of claim 12, wherein the one or more processors are individually or collectively further operable to execute the code to cause the UE to:
execute an artificial intelligence (AI) model to select the value from the range for the at least one parameter that is associated with a PDU set delay budget (PSDB) or a PDU set importance (PSI) level for modifying a radio link control (RLC) level trigger, for modifying a retransmission procedure at a layer that is lower than the RLC level, for modifying a resource for communicating the one or more PDU sets, or for reserving power.

18. The UE of claim 12, wherein the one or more processors are individually or collectively further operable to execute the code to cause the UE to:
monitor one or more key performance indicators (KPIs) associated with at least one PDU set; and
train an artificial intelligence (AI) model based at least in part on the one or more KPIs, wherein the AI model is trained to select the value from the range for the at least one parameter.

19. The UE of claim 12, wherein the value selected from the range modifies a power limitation procedure, channel state information (CSI) reporting, adaptive receive diversity (ARD), or a combination thereof.

20. A network entity, comprising:
one or more memories storing processor-executable code; and
one or more processors coupled with the one or more memories and individually or collectively operable to execute the code to cause the network entity to:
send, to a user equipment (UE), configuration information for configuring the UE to communicate an indication of one or more key performance indicators (KPIs) associated with one or more protocol data unit (PDU) sets, wherein each PDU set of the one or more PDU sets comprises a plurality of PDUs associated with an application data unit (ADU) for communication between the UE and a network; and
communicate, with the UE, the indication of the one or more KPIs associated with the one or more PDU sets based at least in part on the configuration information, wherein the one or more KPIs are associated with a quantity of lost PDU sets or discarded PDU sets of the one or more PDU sets.
